(19) United States
(12) Patent Application Publication
(10) Pub. No.: US 2026/0086351 A1
(43) Pub. Date: Mar. 26, 2026

(54) MULTI-WAVEGUIDE BEAM SCANNERS AND SCANNING PATTERN METHODS

(71) Applicants: The MITRE Corporation, McLean, VA (US); Massachusetts Institute of Technology, Cambridge, MA (US)

(72) Inventors: Matthew ZIMMERMANN, McLean, VA (US); Henry Wen, Reading, MA (US); Dirk Englund, Brookline, MA (US)

(73) Assignees: The MITRE Corporation, McLean, VA (US); Massachusetts Institute of Technology, Cambridge, MA (US)

(21) Appl. No.: 19/093,789

(22) Filed: Mar. 28, 2025

Related U.S. Application Data
(60) Provisional application No. 63/697,897, filed on Sep. 23, 2024.

(51) Int. Cl. G02B 26/10

(52) U.S. Cl. CPC G02B 26/103

(57) ABSTRACT

A photonic system including a cantilever, the cantilever including a plurality of waveguides spaced from one another in a width of the cantilever to project a plurality of respective beams, the plurality of respective beams spaced with a uniform pitch from one another along a dimension of the width, and a piezoelectric layer, the photonic system including one or more voltage sources to apply a voltage across the piezoelectric layer, such that the cantilever deflects along a length of the cantilever when the voltage is applied and a controller to drive the voltage to cause a center point of a tip of the cantilever to translate in a two-dimensional Lissajous pattern.

### CROSS-REFERENCE TO RELATED APPLICATIONS

This application claims the benefit of U.S. Provisional Application No. 63/697,897, filed Sep. 23, 2024, the entire contents of which is incorporated herein by reference.

### FIELD

The present disclosure relates generally to micro-mechanical and nano-mechanical cantilevers for use in microelectromechanical systems (MEMS), photonic devices, micro-robotic devices, and the like.

### BACKGROUND

The scalability of a micron-scale or nano-scale system is often restricted by an inability to effectively interconnect system components without compromising important system characteristics (e.g., size or efficiency). For example, the scalability of a photonic integrated circuit may be limited by an inability to perform crucial functions such as the steerable projection and collection of optical modes between the circuit and a set of targets in free space without using devices that have relatively large footprints (e.g., MEMs mirrors) or devices that are challenging to integrate (e.g., optical phase arrays). These challenges can hamper the development of technologies that can be formed from networks of micron-scale and nano-scale devices.

### SUMMARY

As described above, improved micron-scale and nano-scale technologies, for example for photonic integrated circuits, are needed. As described herein, steerable waveguide cantilevers may be used to direct one or more beams of light in micron-scale and nano-scale devices.

Described are micron-scale and nano-scale curving or curling cantilever structures for use in a wide range of applications, including as components of photonic and electronic integrated circuits. The provided cantilevers can be fabricated using wafer-scale fabrication techniques and materials (e.g., CMOS fabrication techniques and materials) and can comprise a stack of dielectric layers having differing intrinsic stress values. When a cantilever is released from its underlying substrate during fabrication, the non-zero stress gradient across its constituent dielectric layers causes the cantilever to deflect and curve along its length.

The topmost dielectric layer (relative to the substrate to which the cantilever is anchored) of a cantilever can be geometrically configured to amplify the cantilever's deflection along its length. Etching the topmost dielectric layer into a plurality of lateral crossbars, for example, can redirect lateral stress (e.g., stress along the width of the cantilever) in the cantilever along the cantilever's length to increase the deflection of the cantilever. Varying properties of the crossbar pattern such as the crossbar duty cycle can program the curvature of the cantilever and, in some embodiments, can enable to cantilever to assume complex geometric structures once released from the underlying substrate.

The curving of a cantilever can be passive or can be actively controlled. A passive curving cantilever may permanently assume a curved shape after being released from the underlying substrate. Actively controlled curving cantilevers, on the other hand, can be moved as needed between two or more curvature states, e.g., via piezoelectric actuation. For example, an active curving cantilever may be configured to be moved between an undeflected state and a deflected state.

As used herein, cantilever dimensions may be referred to with respect to an x-direction (or x-dimension), a y-direction (or y-dimension), and a z-direction (or z-dimension). This Cartesian convention may be defined with respect to the tip of an active curving cantilever, and may also be used to refer to an imaging plane onto which a light beam from the cantilever projects. The positive 7-direction may be the direction in which light travels in the waveguide along the length of the cantilever, and/or the direction along which light projects from the tip of the cantilever. The x-dimension and y-dimension may be perpendicular to the 2-dimension (e.g., as defined at the tip of the cantilever). The x-dimension may be the width-wise dimension of a cantilever that has an elongated cross-sectional shape, and may be illustrated herein (e.g., in imaging plane diagrams) as the horizontal dimension. The y-dimension may be the thickness dimension of a cantilever that has an elongated cross-sectional shape, and may be illustrated herein (e.g., in imaging plane diagrams) as the vertical dimension. In the example of FIG. 1, the z-dimension is in and out of the page, the y-dimension is vertical, and the x-dimension is horizontal. While this disclosure describes the positive z-direction as the direction in which light travels in the waveguide along the length of the cantilever, a person of skill in the art will appreciate that sign convention for the direction of light propagation is arbitrary. For instance, the sign of the z-direction and the related orientation (e.g., “handedness”) of the Cartesian convention does not affect x-directional and y-directional displacement equations, voltage equations, etc. described herein.

The provided cantilevers can be implemented as optical interconnects in optical systems such as photonic integrated circuits (PICs) by patterning a waveguide channel within the topmost cantilever layer and can enable crucial functionalities such as the steerable projection and collection of multiple optical modes between a PIC and a set of targets in free space. Active curving cantilevers (e.g., piezoelectrically actuated cantilevers) in particular can enable, e.g., two-dimensional beam scanning from anywhere on a photonic chip over a large number of diffraction limited spots in the far field. Advantageously, unlike beam scanning approaches that rely on reflective scanners, integrated optical phase arrays, or scanning fibers, the disclosed cantilevers are highly scalable and have small footprints (e.g., less than 1 mm²), wide fields-of-view, and broadband outputs. As a result, the provided cantilevers can facilitate the creation of complex optical systems such as quantum computers.

Scanning methods (including the use of scanning algorithms) for two-axis resonant devices such as MEMS mirrors, scanning fiber, and on-chip steerable waveguide cantilevers can project over a large area with Lissajous patterns. The frequencies selected can be used to generate either high-speed or high-fill patterns. The repetition rate and fill factor can be determined based on the number of y-directional and x-directional lobes in a Lissajous pattern for a given set of frequencies (see K. Hwang, Y. Seo, J. Ahn, P. Kim, K. Jeoung. “Frequency selection rule for high definition and high frame rate Lissajous scanning.” Nat. Scientific Reports. 7, 14075 (2017)) when the phase is set to maximize density (see J. Wang, G. Zhang, Z. You. “Design rules for dense and rapid Lissajous scanning.” Nat. Microsystems and Nanoengineering. 6, 101 (2020)), where the greatest common divisor (GCD) is equal to the repetition rate, the number of x-directional lobes N_{X}=f_{X}/GCD, the y-directional lobes N_{Y}=f_{Y}/GCD, and the total lobe number N=(f_{X}+f_{Y})/GCD. There is a tradeoff between repetition rates and lobe number, and achieving a high fill factor can take exceedingly long scan times.

Multi-core fiber and multi-waveguide steering cantilevers may project a line of multiple high density beam spots. As described herein, techniques for driving multi-waveguide cantilevers are provided such that the tip of a multi-waveguide cantilever is caused to oscillate in a Lissajous pattern.

With the right scan ranges, a cantilever with multiple waveguides, that may be a component of a photonic integrated circuit, can achieve high fill factors with much lower lobe numbers and much higher repetition rates by interleaving the scans of multiple waveguides, and can be used to create a high-speed, high-fill, efficient beam scanning system. A multi-waveguide device may have N_{WG} waveguides separated along the x-dimension of the multi-waveguide device by uniform pitch p. To maximize the Lissajous scan efficiency with a multi-waveguide device, the center of the multi-waveguide device may be driven with respect to the x-directional and y-directional lobe numbers N_{X} and N_{Y}, the number of waveguides, and the pitch p.

In some embodiments, the tip of a multi-waveguide cantilever is driven to oscillate in a Lissajous pattern such that displacement in an x-direction, along which the multiple waveguides are spaced apart from one another by a periodic pitch, does not exceed the pitch. Each waveguide may therefore oscillate in a Lissajous pattern within an oscillation “zone” that spans the length of the pitch of the waveguides in the x-direction.

Example applications of the cantilevers to several technical fields are also described. In particular, applications of the cantilevers to photonic circuits such as qubit control systems are provided.

According to some embodiments, a photonic system is provided comprising, a cantilever, the cantilever comprising, a plurality of waveguides spaced from one another in a width of the cantilever to project a plurality of respective beams, the plurality of respective beams spaced with a uniform pitch from one another along a dimension of the width, a piezoelectric layer, one or more voltage sources to apply a voltage across the piezoelectric layer, such that the cantilever deflects along a length of the cantilever when the voltage is applied, and a controller to drive the voltage to cause a center point of a tip of the cantilever to translate in a two-dimensional Lissajous pattern.

In any of these embodiments, translating the center point of a tip of the cantilever in the two-dimensional Lissajous pattern causes the beams to form corresponding two-dimensional Lissajous patterns in a target plane.

In any of these embodiments, the system comprises memory storing instructions that, when executed by the controller, causes the controller to drive the voltage so as to translate the center point of a tip of the cantilever in the two-dimensional Lissajous pattern as

$$x ( t ) = p \frac{{N}_{X} {N}_{WC}}{2 \sqrt{2}} cos ( 2 π {f}_{X} t + \frac{2 π}{4 ( {N}_{X} - {N}_{Y} )} ) and$$

$$y ( t ) = p ( \frac{{N}_{X} {N}_{WC}}{2 \sqrt{2}} + \frac{{N}_{WG} - 1}{2} ) cos ( 2 π {f}_{Y} t + \frac{2 π}{4 ( {N}_{X} - {N}_{Y} )} ) ,$$

wherein greatest common divisor (GCD) is equal to repetition rate, number of waveguides=N_{wg}, the uniform pitch=p, number of lobes in an x dimension N_{X}=f_{X}/GCD, number of lobes in a y dimension N_{Y}=f_{Y}/GCD, total lobe number N=(f_{X}+f_{Y})/GCD, frequency in the x dimension=f_{X}, frequency in the y dimension=f_{Y}, a direction propagation of light along the waveguides defines a positive z direction of the cantilever, and the x dimension is the width dimension and is perpendicular to the y dimension, and both the x dimension and y dimension are perpendicular to the z direction and to one another.

In any of these embodiments, the system comprises memory storing instructions that, when executed by the controller, causes the controller to drive the voltage so as to translate the center point of a tip of the cantilever in the two-dimensional Lissajous pattern to create U-shaped, oval-shaped, hourglass-shaped, or M-shaped curves at kHz rates. In any of these embodiments, comprising a diamond waveguide comprising a plurality of color centers, wherein driving the voltage to translate the center point of a tip of the cantilever in the two-dimensional scanning pattern causes the beams to scan over one or more of the plurality of color centers.

In any of these embodiments, the system comprises a first dielectric layer and a second dielectric layer overlying the first dielectric layer, wherein the piezoelectric layer is disposed between the first dielectric layer and the second dielectric layer. In any of these embodiments, wherein the piezoelectric layer comprises a first piezoelectric portion and a second piezoelectric portion that are spaced apart from one another, and applying the voltage across the piezoelectric layer comprises applying a first voltage waveform to the first piezoelectric portion and applying a second voltage waveform to the second piezoelectric portion.

In any of these embodiments, the second dielectric layer comprises a plurality of crossbars oriented at an angle relative to the direction propagation of light along the waveguides in the cantilever to control curvature of the cantilever. In any of these embodiments, comprising memory storing instructions that, when executed by the controller, causes the controller to drive the voltage so as to translate the center point of a tip of the cantilever in the two-dimensional Lissajous pattern, wherein maximum displacement in one direction of the tip of the cantilever in an x dimension of the cantilever is less than or equal to half of uniform pitch, wherein a direction propagation of light along the waveguides defines a positive z direction of the cantilever, and the x dimension is the width dimension and is perpendicular to the y dimension, and both the x dimension and a y dimension are perpendicular to the z direction and to one another.

In any of these embodiments, the center point of the tip of the cantilever is translated in the two-dimensional Lissajous pattern as

$$x ( t ) = \frac{p - \frac{spotsize}{2}}{2} cos ( 2 π {f}_{X} t + \frac{2 π}{4 ( {N}_{X} - {N}_{Y} )} ) and y ( t ) = {A}_{Y} cos ( 2 π {f}_{Y} t + \frac{2 π}{4 ( {N}_{X} - {N}_{Y} )} ) ,$$

wherein the uniform pitch=p, number of lobes in an x dimension=N_{X}, number of lobes in a y dimension=N_{Y}, frequency in the x dimension=f_{X}, frequency in the x dimension=f_{Y}, and A_{y} is an arbitrary constant. In any of these embodiments, wherein each of the plurality of waveguides is translated in a respective Lissajous pattern within a non-overlapping zone with respect to the other waveguides.

In any of these embodiments, the x-dimension displacement of the cantilever tip is defined by x(t)=A_{X} cos(2πf_{X}t+φ_{X}), the voltage causing the x-dimension displacement is defined by V_{X}(t)=A_{V,X}*A_{X}*cos(2πf_{X}t+φ_{X}+θ_{V,X}). A_{X} is an arbitrary amplitude term for displacement, A_{V,X} is an arbitrary amplitude term for voltage, φ_{X}.

In any of these embodiments, the system comprises memory storing instructions that, when executed by the controller, causes the controller to drive the voltage so as to translate the center point of a tip of the cantilever in the two-dimensional Lissajous pattern, wherein maximum displacement in one direction of the tip of the cantilever the width dimension of the cantilever is greater than or equal to half of uniform pitch, thereby causing overlap between oscillation zones defined by the oscillation of the respective waveguides. In any of these embodiments, wherein the instructions cause the controller to activate and deactivate one or more light sources coupled into the plurality of waveguides, wherein the activation and deactivation is timed such that the each of the waveguides projects its respective beam exclusively within a respective oscillation zone associated with the respective waveguide.

In any of these embodiments, the system comprises memory storing instructions that, when executed by the controller, causes the controller to activate and deactivate one or more light sources coupled into the plurality of waveguides such that each of the waveguides projects its respective beam exclusively when the cantilever is translating monotonically in one direction in an x dimension of the cantilever and monotonically in one direction in a y dimension of the cantilever, wherein a direction propagation of light along the waveguides defines a positive z direction of the cantilever, and the x dimension is the width dimension and is perpendicular to the y dimension, and both the x dimension and a y dimension are perpendicular to the z direction and to one another. In any of these embodiments, wherein activation and deactivation of the one or more light sources causes the projection, by each of the waveguides, of a respective plurality of non-overlapping lines within a respective oscillation zone associated with the respective waveguide.

According to some embodiments, a method is provided, the method performed at a photonic system comprising a cantilever, the cantilever comprising a plurality of waveguides spaced from one another in a width of the cantilever to project a plurality of respective beams, the plurality of respective beams spaced with a uniform pitch from one another along a dimension of the width, a piezoelectric layer, one or more voltage sources, and a controller, the method comprising, driving, by the controller, a voltage across the piezoelectric layer, such that the cantilever deflects along a length of the cantilever when the voltage is applied, to cause a center point of a tip of the cantilever to translate in a two-dimensional Lissajous pattern.

Any one or more features from any of the above embodiments may be combined, in whole or in part, with all or part of any of the other embodiments and/or with all or part of any other disclosure herein.

### BRIEF DESCRIPTION OF THE FIGURES

The invention will now be described, by way of example only, with reference to the accompanying drawings. The patent or application file contains at least one drawing executed in color. Copies of this patent or patent application publication with color drawings will be provided by the office upon request and payment of the necessary fee.

FIG. 1 illustrates a photonic system with a controllable cantilever waveguide (e.g., piezoelectrically actuated cantilever) that can enable two-dimensional beam scanning, such as a two-dimensional Lissajous pattern, according to some embodiments.

FIG. 2A illustrates a simulated projection of a 4:3 Lissajous pattern with 7 lobes from (i) 1 and (ii) 8 waveguides, with fill factors measured for a 128×128 pixel array, according to some embodiments.

FIG. 2B illustrates a simulated projection of a 7:9 Lissajous pattern from (i) 1 and (ii) 8 waveguides, with fill factors measured for 128×128 pixel array, according to some embodiments.

FIG. 2C illustrates a head-on view of a multi-waveguide scanner (e.g., multi-waveguide cantilever) with 4 and 8 embedded waveguides, according to some embodiments.

FIG. 2D illustrates Fill Factors with respect to lobe number for an 8-waveguide scanning device (e.g., 8-waveguide cantilever) for 128×128, 256×256, 512×512, and 1024×1024 pixel areas, according to some embodiments.

FIG. 2E illustrates a table with 95% Fill requirements for N_{WG}=8, 4, and 1, with scan rates for f_{X}≃4.8 kHz and f_{Y}≃6.4 kHz, the microcantilever's x-directional and y-directional resonance frequencies, according to some embodiments.

FIG. 3A illustrates a microcantilever with separate left and right actuation regions and four embedded waveguides, according to some embodiments.

FIG. 3B illustrates a photograph of a microcantilever device with 8 embedded waveguides, according to some embodiments.

FIG. 3C illustrates a frequency response from a single waveguide split actuator device when driving both actuation regions in-phase or out-of-phase, according to some embodiments.

FIG. 3D illustrates an SEM image of a quantum microchiplet with 8 diamond waveguides, according to some embodiments.

FIG. 3E illustrates high-rate patterns for addressing waveguides on a quantum microchiplet, according to some embodiments.

FIG. 4 illustrates a simulated ‘between the pitch’ scan, in which each waveguide of a multi-waveguide cantilever traces a 5:1 (e.g., N_{Y}=5, N_{X}=1) Lissajous pattern, according to some embodiments.

FIG. 5A illustrates a simulated ‘between the pitch’ scan, in which each waveguide of a multi-waveguide cantilever traces a 1:1 (e.g., N_{Y}=1, N_{X}=1) Lissajous pattern, according to some embodiments.

FIG. 5B illustrates a simulated ‘between the pitch’ scan, in which each waveguide of a multi-waveguide cantilever traces a 9:8 Lissajous pattern, according to some embodiments.

FIG. 5C illustrates a simulated ‘between the pitch’ and ‘southwest’ scan, in which each waveguide of a multi-waveguide cantilever traces a 9:8 Lissajous pattern, according to some embodiments.

FIG. 6A illustrates a simulated ‘between the pitch’ scan, in which each waveguide of a multi-waveguide cantilever traces a 2:1 Lissajous pattern, according to some embodiments.

FIG. 6B illustrates a simulated ‘between the pitch’ scan, in which each waveguide of a multi-waveguide cantilever traces a 17:8 Lissajous pattern, according to some embodiments.

FIG. 6C illustrates a simulated ‘between the pitch’ and ‘southwest’ scan, in which each waveguide of a multi-waveguide cantilever traces a 17:8 Lissajous pattern, according to some embodiments.

FIG. 7A illustrates a simulated ‘between the pitch’ scan, in which each waveguide of a multi-waveguide cantilever traces a 3:1 Lissajous pattern, according to some embodiments.

FIG. 7B illustrates a simulated ‘between the pitch’ scan, in which each waveguide of a multi-waveguide cantilever traces a 25:8 Lissajous pattern, according to some embodiments.

FIG. 7C illustrates a simulated ‘between the pitch’ and ‘southwest’ scan, in which each waveguide of a multi-waveguide cantilever traces a 25:8 Lissajous pattern, according to some embodiments.

FIG. 8A illustrates a simulated ‘between the pitch’ and ‘southwest’ scan, in which each waveguide of a multi-waveguide cantilever traces a 9:8 Lissajous pattern at the cantilever's y-directional frequency of f_{Y}=1080 Hz, according to some embodiments.

FIG. 8B illustrates a simulated ‘between the pitch’ and ‘southwest’ scan, in which each waveguide of a multi-waveguide cantilever traces a 9:8 Lissajous pattern at the cantilever's y-directional frequency of f_{Y}=2040 Hz, according to some embodiments.

FIG. 8C illustrates a simulated ‘between the pitch’ and ‘southwest’ scan, in which each waveguide of a multi-waveguide cantilever traces a 9:8 Lissajous pattern at the cantilever's y-directional frequency of f_{Y}=3000 Hz, according to some embodiments.

FIG. 9A illustrates a simulated ‘between the pitch’ scan, in which each waveguide of a multi-waveguide cantilever traces a 5:1 Lissajous pattern across an x-directional range of

$$\pm \frac{p - spotsize / 2}{2} ,$$

according to some embodiments.

FIG. 9B illustrates a simulated ‘between the pitch’ scan, in which each waveguide of a multi-waveguide cantilever traces a 5:1 Lissajous pattern across an x-directional range of

$$\pm \frac{p}{2} ,$$

according to some embodiments.

FIG. 10A illustrates a simulated 9:8 Lissajous pattern, in which a multi-waveguide cantilever traces the Lissajous pattern and the multi-waveguide cantilever is displaced with an x-directional range of ±2p, according to some embodiments.

FIG. 10B illustrates a simulated ‘southwest’ scan of a 9:8 Lissajous pattern, in which a multi-waveguide cantilever traces the Lissajous pattern across an x-directional range of ±2p, according to some embodiments.

FIG. 10C illustrates a temporal order of scanlines of a simulated ‘southwest’ scan of a 9:8 Lissajous pattern, in which a multi-waveguide cantilever traces the Lissajous pattern across an x-directional range of ±2p, according to some embodiments.

FIG. 11A illustrates a simulated 9:8 Lissajous pattern, in which a multi-waveguide cantilever traces the Lissajous pattern across an x-directional range of ±0.6488, according to some embodiments.

FIG. 11B illustrates a simulated ‘southwest’ scan of a 9:8 Lissajous pattern, in which a multi-waveguide cantilever traces the Lissajous pattern across an x-directional range of ±0.6488, according to some embodiments.

FIG. 11C illustrates a temporal order of scanlines of a simulated ‘southwest’ scan of a 9:8 Lissajous pattern, in which a multi-waveguide cantilever traces the Lissajous pattern across an x-directional range of ±0.6488p, according to some embodiments.

FIG. 12 illustrates a computing unit, according to some embodiments.

### DETAILED DESCRIPTION

Described are micron-scale and nano-scale curving or curling cantilever structures and devices and systems including such structures for use in a wide range of applications. For example, described are cantilever structures that can be used as components of photonic and electronic integrated circuits. The provided cantilevers can be fabricated using wafer-scale fabrication techniques and materials (e.g., conventional CMOS fabrication techniques and materials). An exemplary cantilever can comprise a stack of dielectric layers having differing intrinsic stress values. When the cantilever is released from its underlying substrate during fabrication, the non-zero stress gradient across its constituent dielectric layers causes the cantilever to deflect and curve along its length.

The topmost dielectric layer (relative to the substrate to which the cantilever is anchored) of a cantilever can be geometrically configured to amplify the cantilever's deflection along its length. Etching the topmost dielectric layer into a plurality of lateral crossbars, for example, can redirect lateral stress (e.g., stress along the width of the cantilever) in the cantilever along the cantilever's length to increase the deflection of the cantilever. Varying properties of the crossbar pattern such as the crossbar duty cycle can program the curvature of the cantilever and, in some embodiments, can enable to cantilever to assume complex geometric structures once released from the underlying substrate.

The curving of a cantilever can be passive or can be actively controlled. A passive curving cantilever may permanently assume a curved shape after being released from the underlying substrate. Actively controlled curving cantilevers, on the other hand, can be moved as needed between two or more curvature states, e.g., via piezoelectric actuation. For example, an active curving cantilever may be configured to be moved between an undeflected state and a deflected state.

The provided cantilevers can be implemented as optical interconnects in optical systems such as photonic integrated circuits (PICs) by patterning a waveguide channel within the topmost cantilever layer and can enable crucial functionalities such as the steerable projection and collection of multiple optical modes between a PIC and a set of targets in free space. Active curving cantilevers (e.g., piezoelectrically actuated cantilevers) in particular can enable, e.g., two-dimensional beam scanning from anywhere on a photonic chip over a large number of diffraction limited spots in the far field. Advantageously, unlike beam scanning approaches that rely on reflective scanners, integrated optical phase arrays, or scanning fibers, the disclosed cantilevers are highly scalable and have small footprints (e.g., less than 1 mm²), wide fields-of-view, and broadband outputs. As a result, the provided cantilevers can facilitate the creation of complex optical systems such as quantum computers.

According to various embodiments, cantilevers configured according to the principles described herein are used in micro- and nano-electromechanical systems (MEMs and NEMs), micro- and nano-scale robotics, and self-assembling micro- and nano-scale structures.

Any of the systems, methods, techniques, and/or features disclosed herein may be combined, in whole or in part, with any other disclosed systems, methods, techniques, and/or features. As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations. When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Photonic System with Active Curving Cantilever

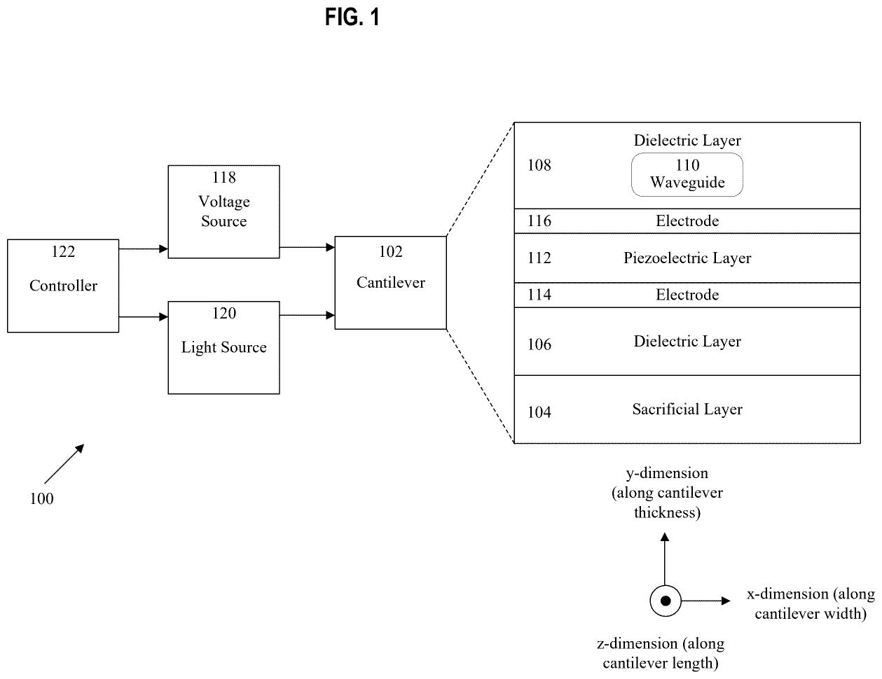

FIG. 1 illustrates a photonic system 100 with an active curving cantilever 102 (e.g., piezoelectrically actuated cantilever) that can enable two-dimensional beam scanning, such as a two-dimensional Lissajous pattern. The cantilever 102 may include several layers: a sacrificial (i.e., release) layer 104, a first, bottom dielectric layer 106, and a second, top dielectric layer 108. Sacrificial layer 104 may bind cantilever 102 to a substrate (e.g., a substrate of an integrated circuit chip) and may be any material layer deposited in the layer stack of cantilever 102 that can be preferentially removed or etched away, e.g., by a wet chemical etch or a gaseous chemical etch, compared to the other materials that constitute cantilever 102 in order to release the overlying layers of cantilever 102 (layers 106-108) from the substrate. For example, sacrificial layer 104 may be a layer of amorphous silicon that can be etched away using a xenon difluoride gas that does not etch the overlying cantilever layers (layers 106-108). An amorphous silicon sacrificial layer can also be removed using various concentrations of potassium hydroxide. If the overlying dielectric layers 106 and 108 do not comprise silicon dioxide, then sacrificial layer 104 can be silicon dioxide or another oxide glass and may be removed using a wet etch of hydrofluoric acid.

Dielectric layers 106 and 108 may be any thin film dielectrics having intrinsic stresses (e.g., silicon dioxide or silicon nitride). The intrinsic stress of layer 108 may be different (e.g., more compressive or more tensile) than the intrinsic stress of layer 106; this difference may be the result of material or chemical differences between layer 106 and layer 108 or, if layer 106 and layer 108 have the same chemical composition, the result of differences in the conditions under which each layer was deposited during the fabrication of cantilever 102. For example, if both layer 106 and layer 108 comprise silicon dioxide or silicon nitride, layer 106 may be configured to have a different intrinsic stress than layer 108 by depositing layer 106 at a different flow rate than the flow rate used to deposit layer 108. Other deposition conditions that may be varied in order to configure the stresses of layers 106 and 108 include the mixture of precursor gases used during deposition, plasma pressure, plasma frequency, and power in a chemical vapor deposition chamber. Post-deposition annealing can also change the intrinsic stress of an as-deposited film.

The second dielectric layer 108 may comprise a plurality of crossbars oriented at an angle relative to the z-dimension of the cantilever 102 to control curvature in a lateral dimension of the cantilever 102. Each crossbar may have a length l_{c}, a width w_{c}, and a height h_{c} and may be oriented at an angle θ_{c} relative to the z-dimension of cantilever 102.

When sacrificial layer 104 is removed and cantilever 102 is released from the substrate, the gradient of intrinsic stress between layer 106 and layer 108 may cause cantilever 102 to deflect along its length relative to the substrate. In order to concentrate the deflection caused by the gradient of intrinsic stress between layer 106 and layer 108 in the x-direction and y-direction and to reduce strain in cantilever 102 that can cause cantilever 102 to curl along its width, layer 108 can be geometrically patterned atop layer 106 such that strain is redirected along the length of cantilever 102 in the z-direction to increase the amount by which cantilever 102 deflects in the x-dimension and y-dimension. In some embodiments, the geometric patterning of the dielectric layer 108 causes cantilever 102 to deflect along its length in a direction away from the substrate. In other embodiments, the geometric patterning of the dielectric layer 108 causes cantilever 102 to deflect along its length in a direction toward the substrate (e.g., causes cantilever 102 to form a semi-circular or semi-ellipsoid arch relative to the substrate). In other embodiments, the geometric patterning of the dielectric layer 108 causes cantilever 102 to twist one or more times along its length to form a (partial) helix. In other embodiments, the geometric patterning of the dielectric layer 108 causes cantilever 102 to twist along its length and to deflect along its length.

The cantilever 102 may include a plurality of waveguides (e.g., number of waveguides, N_{WG}) patterned in the dielectric layer 108. For instance, the cantilever 102 may include a waveguide 110 oriented along the length of cantilever 102 and that forms a channel within the dielectric layer 108. Waveguide 110 may be formed using a dielectric material with low optical loss (e.g., optical loss of less than 1 dB/cm). Waveguide 110 may be oriented parallel to the length of the cantilever (e.g., oriented along the z-direction) and can be positioned proximally or distally to the center of cantilever 102. Light from a light source 120, such as a laser, may be coupled into the plurality of waveguides (e.g., the waveguide 110) of the cantilever 102. In some embodiments, each waveguide of the plurality of waveguides is coupled to a light source, such as the light source 120. For instance, a first waveguide of the cantilever 102 may receive light from a light source that outputs light at a frequency A, and a second waveguide of the cantilever 102 may receive light from a light source that outputs light at a frequency B. In some embodiments, one or more waveguides of the plurality of waveguides is coupled to a light source, such as the light source 120, that outputs light at a plurality of frequencies. For instance, the first waveguide of the cantilever 102 may receive light from a light source that outputs light at a frequency A and outputs light at a frequency B. A second waveguide of the cantilever 102 may receive light from said light source, or a light source the outputs light at a frequency C and outputs light at a frequency D. In some embodiments, each waveguide of the plurality of waveguides is coupled to one or more light sources. Each light source of the one or more light sources may be an exemplary embodiment of the light source 120, and each light source may be configured to output light at a frequency or output light at a plurality of frequencies. For instance, the first waveguide of the cantilever 102 may receive light from a first light source that outputs light at a frequency A and/or from a second light source that outputs light at a frequency B and outputs light at a frequency C. The second waveguide of the cantilever 102 may receive light from said first and/or second light sources, or may receive light from a third light source that outputs light at a frequency C and/or from a fourth light source that outputs light at a frequency D and outputs light at a frequency E. In some embodiments, light output by one or more of the light sources and input into one of more of the waveguides may be frequency-multiplexed light.

The cantilever 102 can be configured such that the deflection is actively controllable. That is, rather than being configured to deflect and remain deflected following its release from its substrate, the cantilever 102 may be configured to deflect on-demand. Control of the deflection of the cantilever 102 may be binary (e.g., cantilever 102 may be switchable between an undeflected state and a single deflected state), discrete (e.g., cantilever 102 may be switchable between an undeflected state and two or more distinct deflected states), or continuous (e.g., cantilever 102 may be adjustable between a continuum of configurations between an undeflected state and a fully deflected state).

Cantilever 102 may comprise a piezoelectric layer 112 of piezoelectric material overlying a first dielectric layer 106. Sandwiching piezoelectric layer 112 may be a pair of conductive electrodes 114 and 122. Electrodes 114 and 122 may be electrically connected (e.g., by wires or conductive traces in the substrate to which cantilever 102 is anchored) to one or more voltage sources (e.g., a battery, an AC/DC power supply, etc.), such as voltage source 118. Applying a voltage across piezoelectric layer 112 using the voltage source 108 may cause piezoelectric layer 112 to mechanically deform. If the voltage is applied to piezoelectric layer 112 when sacrificial layer 104 is removed and cantilever 102 is released, the mechanical deformation of piezoelectric layer 112 may cause cantilever 102 to deflect along its length.

In some embodiments, the one or more voltage sources, such as the voltage source 118, may be configured to apply AC voltages across the piezoelectric layer 112, and the AC voltages may be controlled by a controller 122. As such, the piezoelectric layer 112 may be controlled by a controller 122 that is configured to generate AC signals. In some embodiments, controller 112 comprises a function generator or an arbitrary waveform generator. In other embodiments, controller 112 enables digital signal driving. For example, controller 112 can generate the AC signals using a clock running on an embedded processor, a field programmable gate array (FPGA), a phase lock loop (PLL), or a voltage-controlled oscillator (VCO). A digital controller may simplify the electronic control of cantilever 102 and increase the scalability of the photonic system 100.

When cantilever 102 is driven with AC voltages of specific frequencies, cantilever 102 may demonstrate one or more y-directional resonances (at frequencies f_{Y}) and one or more x-directional resonances (at frequencies f_{X}). This may enable the tip of the waveguide 110 of cantilever 102 (e.g., tip of the cantilever 102) to be moved both in the y-dimension and in the x-dimension. The frequencies at which cantilever 102 demonstrates the y-directional and x-directional resonances can be observed from kilohertz to megahertz rates and can vary based on the length, width, and geometrical properties of cantilever 102. The light from the light source 120 that is output from the tip of cantilever 102 through the waveguide 110 can be projected in two-dimensional space by driving cantilever 102 at these resonances while modulating the light (e.g., such as turning on and off the light from the light source 102 at specific intervals in time). Cantilever 102 can therefore be used for 2D beam steering applications including (but not limited to) projecting a beam spot onto an atomic array of color centers (e.g., in a quantum computing system), performing 2D LiDAR scanning, and projecting an image in 2D space, such as projecting a Lissajous pattern in 2D space.

In some embodiments, two dimensional control of cantilever 102 is accomplished by driving piezoelectric layer 112 with an AC voltage. The piezoelectric layer 112 may be driven with the AC voltage in accordance with a desired two-dimensional control (e.g., X-directional displacement and Y-directional displacement) of the cantilever 102, where X and Y are defined as perpendicular dimensions to the z-directional projection of light as described above. For instance, if a desired X-directional displacement is of the form x(t)=A_{X} cos(2πf_{X}t+φ_{X}) (where A_{X} is an arbitrary amplitude term for displacement and φ_{X} is a phase offset term for displacement), then the piezoelectric layer 112 may be driven with an AC voltage of the form V_{X}(t)=A_{V,X}*A_{X}*cos(2πf_{X}t+φ_{X}+θ_{V,X}) (where A_{V,X} is an arbitrary amplitude term for voltage and Ov x is a phase offset term for voltage). A similar AC voltage form may be generated for V_{Y}(t) that is based on y(t), such that for two-dimensional control, the net AC voltage used to drive the piezoelectric layer 112 may be of the form V(t)=V_{X}(t)+V_{Y}(t). As such, a difference between the desired two-dimensional displacement of the cantilever 102 and the AC voltage to generate said two-dimensional displacement may understood by the inclusion of another amplitude scaling factor and at least one phase offset both included in the voltage equation that are not included in the displacement equation. In some embodiments, a user adjusts the amplitude scaling factor(s) and the phase offset(s) of the AC voltage to achieve the desired two-dimensional displacement of the cantilever 102 by: driving the piezoelectric layer 112 with an AC voltage, measuring the X-directional displacement and the Y-directional displacement of the cantilever 102, and adjusting the amplitude scaling factor(s) and/or the phase offset(s) of the AC voltage until the measured X-directional and Y-directional displacements are in accordance with the desired two-dimensional displacement.

While driving piezoelectric layer 112, light that is input into waveguide 110 may be modulated using an optical modulator (e.g., a shutter or an acousto-optic modulator). This control process can be used to perform a raster scan or to trace a Lissajous pattern. The phases Øx. Øy can be adjusted to change the shape of the Lissajous pattern. Synchronously modulating the input light with the pattern traced by the cantilever tip may display an image or allow a specific pattern to be traced.

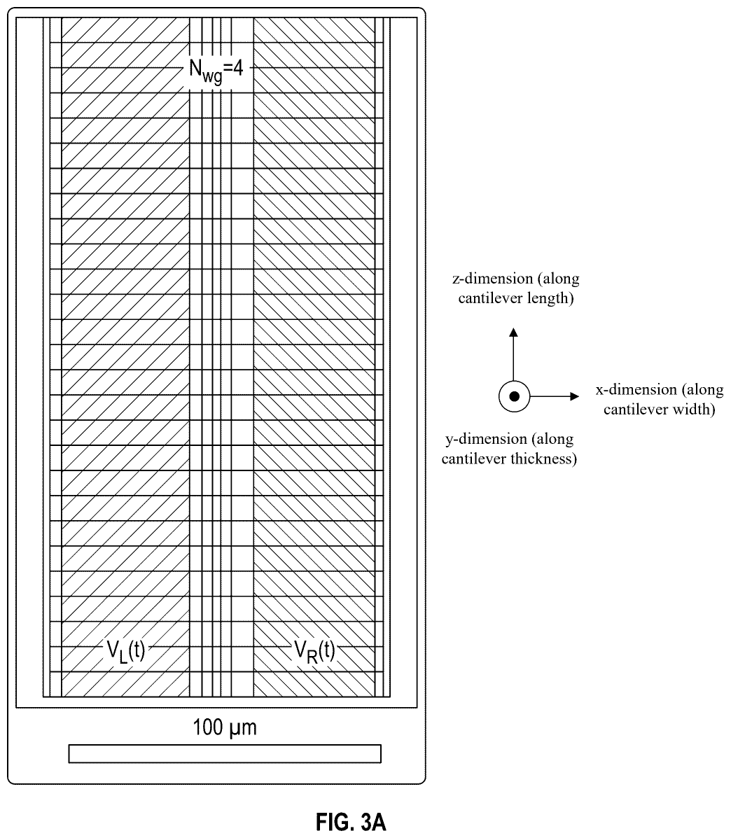

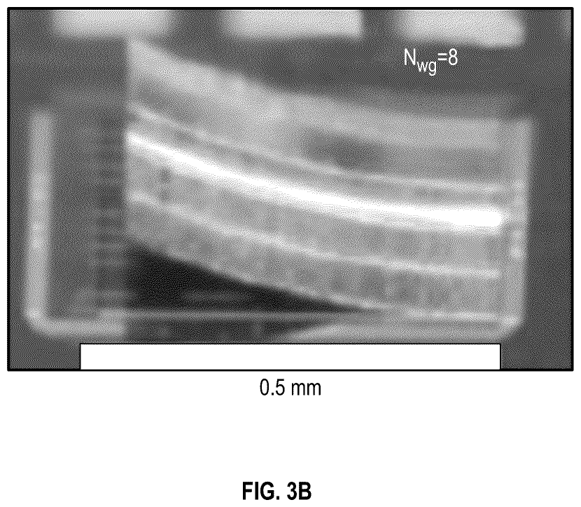

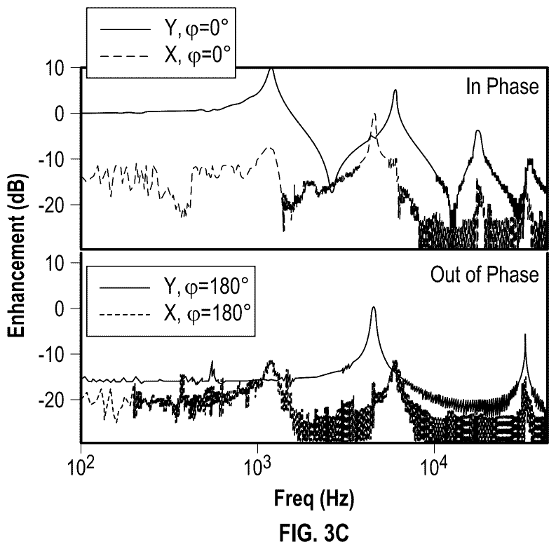

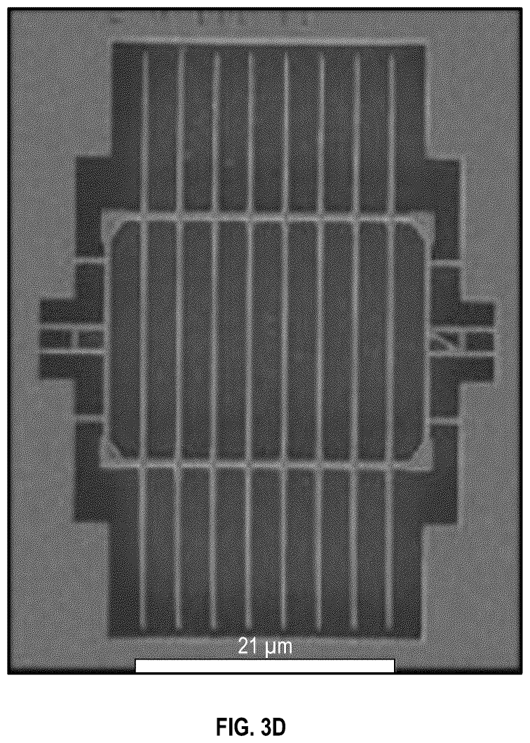

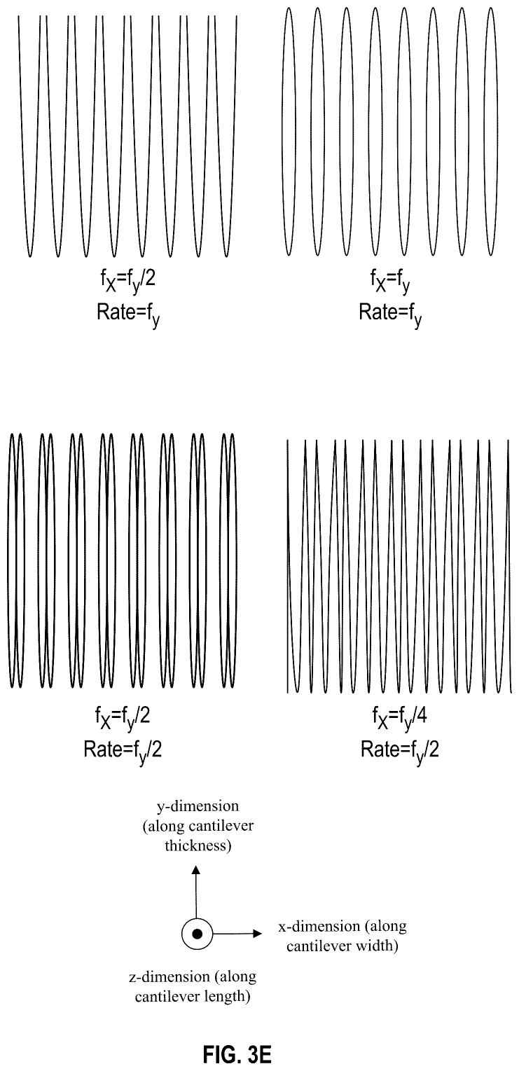

In some embodiments, the cantilever 102 includes a first piezoelectric actuator disposed between the first dielectric layer 106 and the second dielectric layer 108, wherein the first piezoelectric actuator is located in a first x-directional half of the cantilever 102 (see FIG. 3A for cantilever with two actuators spaced apart from one another in the x-direction). The cantilever 102 may also include a second piezoelectric actuator disposed between the first dielectric layer 106 and the second dielectric layer 108, wherein the second piezoelectric actuator is located in a second x-directional half of the cantilever (see FIG. 3A for cantilever with two actuators spaced apart from one another in the x-direction). The first and second piezoelectric actuators are exemplary embodiments of the piezoelectric layer 112. In some embodiments, two-dimensional control of the cantilever 102 is accomplished by driving the first piezoelectric actuator with a first AC voltage (e.g., such as V_{X}(t) described herein) and driving the second piezoelectric actuator with a second AC voltage (e.g., such as V_{Y}(t) described herein).

Raster scanning can be accomplished via low-frequency, off-resonant signal scanning of the x-dimension of the cantilever and high-frequency, resonant signal scanning of the y-dimension of the cantilever. The light modulating signal may project scanlines. Lissajous scanning (e.g., projecting the Lissajous pattern in 2D space) can be performed using dual resonances to simultaneously scan both the x-dimension and y-dimension of the imaging plane.

The repetition rate may be the greatest common divisor (GCD) between the y-directional resonance frequency and the x-directional resonance frequency. The refresh rate may be the speed (in Hz) at which cantilever 102 traces a pattern (e.g., projects an image) across a given imaging plane and returns to a starting x-directional and y-directional position. The refresh rate may depend on the ratio between the y-directional resonance frequency and the x-directional resonance frequency. A fill factor may be the percentage of an area of the imaging plane that is traversed by at least one beam spot projected from the cantilever. For applications such as atomic color center excitation, a high repetition rate can be beneficial. For applications such as image projection and LiDAR scanning, a high refresh rate may be more desirable.

### High-Speed, High-Fill Beam Scanning Via Multi-Waveguide Cantilever

In some embodiments, the repetition rate, refresh rate, and fill factor may depend on the number of y-directional lobes and x-directional lobes in a Lissajous pattern for a given set of y-directional and x-directional resonance frequencies when the phase (e.g., such as a phase of the x(t) and/or y(t) displacements of Equation 1 and/or 2, respectively) is adjusted to maximize line density of the Lissajous pattern (e.g., maximize fill pattern of the Lissajous pattern). The number of y-directional lobes is N_{Y}=f_{Y}/GCD, the number of x-directional lobes is N_{X}=f_{X}/GCD, and a total lobe number in a Lissajous pattern is N=(f_{X}+f_{Y})/GCD. A multi-waveguide active curving (e.g., active steering) cantilever, such as cantilever 102, may receive light from a multi-core fiber connected to one or more light sources, such as light source 120, and the cantilever 102 may project a line of multiple high density beam spots, such that each beam spot is projected from a waveguide of the cantilever 102. With the right scan ranges (e.g., x-directional and y-directional frequencies, beam spot size, A_{X}, A_{y}, etc.) the cantilever 102 may be used to generate a high-speed (e.g., high refresh rate), high-fill, efficient beam scanning system. For instance, the cantilever 102 may achieve high fill factors with much lower lobe numbers and much higher repetition rates by interleaving the scans (e.g., Lissajous patterns) of the multiple waveguides, which may diminish the scan time necessary to produce a high fill factor scan. In some embodiments, a high-speed beam scanning system traces a Lissajous pattern with high frame rates. For display applications, a high-speed beam scanning system may trace a Lissajous pattern with a frame rate of 60 Hz or 120 Hz. In some embodiments, a high-fill beam scanning system yields a traced Lissajous pattern with at least 95% of the area of the imaging plane traversed by at least one beam spot projected from the cantilever. In some embodiments, the multi-waveguide active curving cantilever produces high fill factors at rates significantly higher than a single-waveguide active curving cantilever.

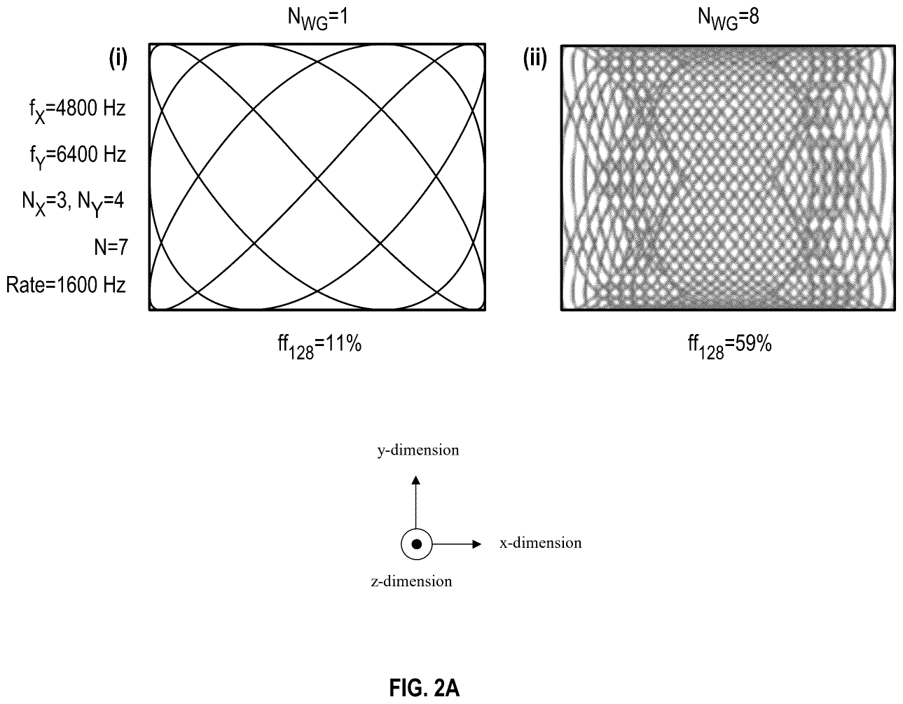

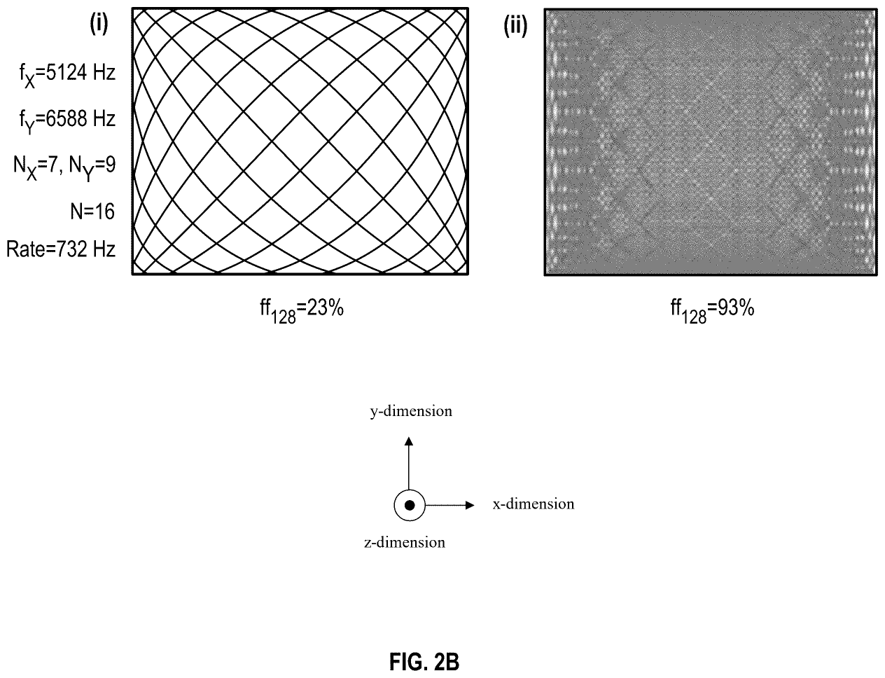

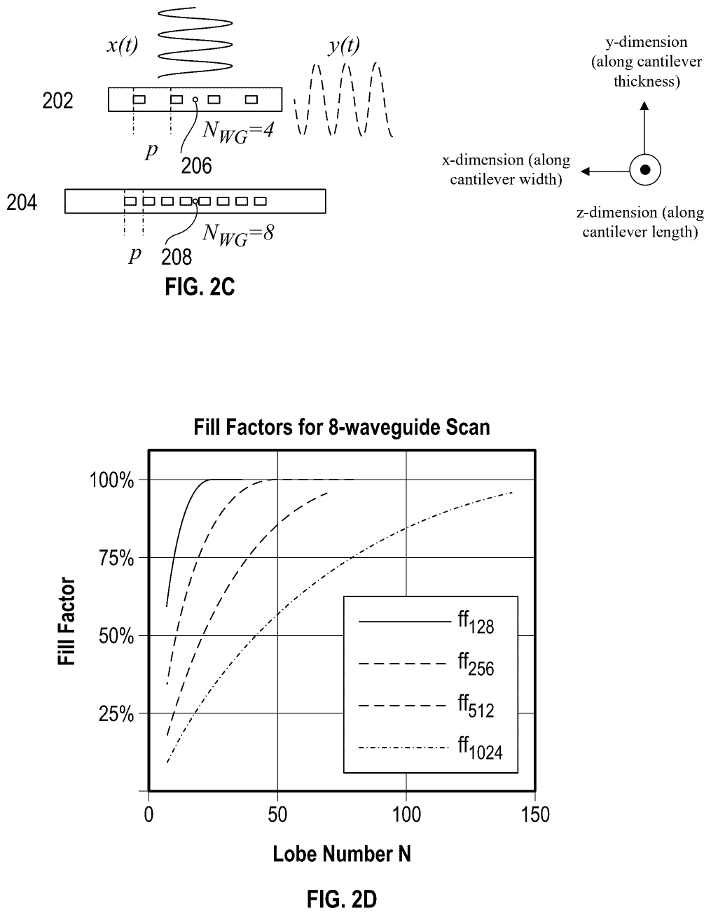

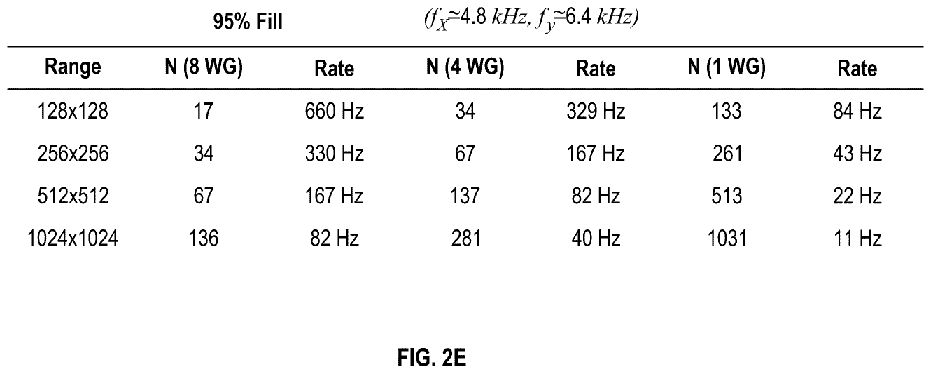

FIGS. 2A-2E show various aspects of the high-speed, high-fill, efficient beam scanning system. FIG. 2A shows a simulated projection of a 4:3 Lissajous pattern with 7 lobes from 1 and 8 waveguides, with fill factors measured for a 128×128 pixel array. FIG. 2B shows a simulated projection of a 7:9 Lissajous pattern from 1 and 8 waveguides, with fill factors measured for 128×128 pixel array. FIG. 2C shows a head-on view of a multi-waveguide scanner with 4 and 8 embedded waveguides. FIG. 2D shows Fill Factors with respect to lobe number for an 8-waveguide scanning device (e.g., 8-waveguide cantilever) for 128×128, 256×256, 512×512, and 1024×1024 pixel areas. FIG. 2E shows a table with 95% Fill requirements for N_{WG}=8, 4, and 1, with scan rates for f_{X}≃4.8 kHz and f_{Y}≃6.4 kHz, the microcantilever's x-directional and y-directional resonance frequencies.

Specifically, FIG. 2C illustrates a multi-waveguide cantilever 202 with N_{WG}=4 and a multi-waveguide cantilever 204 with N_{WG}=8 that may both be used to generate the high-speed, high-fill, efficient beam scanning system. The cantilever 202 and the cantilever 204 may comprise the same layers as cantilever 102 of FIG. 1. As shown, the cantilever 202 may have four waveguides patterned in a second dielectric layer (e.g., such as second dielectric layer 108 of cantilever 102 of FIG. 1), and the four waveguides may be uniformly separated by pitch p along the x-dimension of the cantilever (e.g., width of the cantilever). Similarly, the cantilever 204 may have eight waveguides patterned in a second dielectric layer (e.g., such as second dielectric layer 108 of cantilever 102 of FIG. 1), and the eight waveguides may be uniformly separated by the pitch p along the x-dimension of the cantilever (e.g., width of the cantilever).

To maximize the Lissajous scan efficiency with a multi-waveguide cantilever (e.g., the cantilevers 202 and 204), the center of the multi-waveguide cantilever (e.g., center 206 and center 208 of the cantilevers 202 and 204, respectively) may be displaced with respect to the x-directional lobe number (e.g., N_{X}), y-directional lobe number (e.g., N_{Y}), the number of waveguides (e.g., N_{WG}), and the pitch p. If N_{X}≠N_{Y}, an AC voltage (e.g., generated by a controller, such as controller 112 of FIG. 1) may be applied to the multi-waveguide cantilevers via one or more voltage sources (e.g., such as voltage source 118 of FIG. 1) to cause oscillatory displacement of the multi-waveguide cantilevers that obeys the following x(t) and y(t) equations:

$$x ( t ) = p \frac{{N}_{Y} {N}_{WG}}{2 \sqrt{( 2 )}} cos ( 2 π {f}_{X} t + \frac{2 π}{4 ( {N}_{X} - {N}_{Y} )} ) \qquad Equation 1$$

$$y ( t ) = p ( \frac{{N}_{Y} {N}_{WG}}{2 \sqrt{( 2 )}} + \frac{{N}_{WG} - 1}{2} ) cos ( 2 π {f}_{Y} t + \frac{2 π}{4 ( {N}_{X} - {N}_{Y} )} ) . \qquad Equation 2$$

If N_{X}=N_{Y}, the AC voltage may be applied to the multi-waveguide cantilevers to cause oscillatory displacement of the multi-waveguide cantilevers that obeys the following x(t) and y(t) equations:

$$x ( t ) = p \frac{{N}_{Y} {N}_{WG}}{2 \sqrt{( 2 )}} cos ( 2 π {f}_{X} t + \frac{π}{2} ) \qquad Equation 3$$

$$y ( t ) = p ( \frac{{N}_{Y} {N}_{WG}}{2 \sqrt{( 2 )}} + \frac{{N}_{WG} - 1}{2} ) cos ( 2 π {f}_{Y} t ) . \qquad Equation 4$$

These scan ranges (e.g., as determined by Equations 1 and 2) create a maximally efficient Lissajous pattern by evenly spacing the Lissajous scan with respect to the waveguide pitch p and number of waveguides (e.g., number of waveguides of the cantilevers 202 and 204). FIGS. 2A and 2B depict exemplary Lissajous patterns that may be projected from a multi-waveguide cantilever, such as cantilever 202 or cantilever 204 of FIG. 2C, as the multi-waveguide cantilever is driven with an AC voltage that causes oscillatory displacement of the multi-waveguide cantilever that obeys Equation 1 and Equation 2 (or Equation 3 and Equation 4). Specifically, FIGS. 2A(i) and 2A(ii) depict a projection of a maximum-fill 4:3 (e.g., N_{Y}=4 and N_{X}=3) Lissajous pattern with N=7, f_{X}=4800 Hz, f_{Y}=6400 Hz, and a repetition rate of 1600 Hz (e.g., GCD=1600 Hz). A projection of a maximum-fill Lissajous pattern may be a projection of a Lissajous pattern in which adjacent lines of the Lissajous pattern are largely evenly spaced and the multi-waveguide cantilever does not trace each line of the Lissajous pattern more than once (e.g., lines of the Lissajous pattern do not overlap). (A minimum-fill Lissajous pattern, on the other hand, may be a pretzel-style Lissajous pattern.) A maximum-fill Lissajous pattern may be generated by: adjusting a phase of Equation 1 and/or Equation 2 and driving the multi-waveguide cantilever with an AC voltage in accordance with the adjusted Equation 1 and/or the adjusted Equation 2 until the spacing of the adjacent lines of the projected Lissajous pattern are largely evenly spaced and the multi-waveguide cantilever does not trace each line of the Lissajous pattern more than once. As such, adjusting the phase of Equation 1 and/or Equation 2 and adjusting the AC voltage in accordance with the adjusted Equation 1 and/or adjusted Equation 2 affects the spacing of adjacent lines of the projected Lissajous pattern. For a cantilever with 1 waveguide, the cantilever may project the 4:3 Lissajous pattern with a fill factor of 11% measured for a 128×128 pixel array (see FIG. 2A(i)). For a cantilever with 8 waveguides, the cantilever may project the 4:3 Lissajous pattern with a fill factor of 59% measured for the 128×128 pixel array (see FIG. 2A(ii)). FIGS. 2B(i) and 2B(ii) depict a projection of a maximum-fill 7:9 (e.g., N_{Y}=9 and N_{X}=7) Lissajous pattern with N=16, f_{X}=5124 Hz, f_{Y}=6588 Hz, and a repetition rate of 732 Hz (e.g., GCD=732 Hz). For a cantilever with 1 waveguide, the cantilever may project the 7:9 Lissajous pattern with a fill factor of 23%, measured for a 128×128 pixel array (see FIG. 2B(i)). For a cantilever with 8 waveguides, the cantilever may project the 7:9 Lissajous pattern with a fill factor of 93%, measured for the 128×128 pixel array (see FIG. 2B(ii)).

Additionally, this multi-waveguide scan avoids ‘bunching’ along the left and right sides of the scan to more evenly distribute the fill, such as depicted in the left and right sides of FIGS. 2B(i)-2B(ii). As an alternative to using the waveguide pitch to calculate the cantilever's scan range (e.g., X-directional displacement and Y-directional displacement associated with Equations 1 and 2, respectively), the pitch from the projected beams can be used to set the projected scan range of one beam. For instance, the cantilever's scan range may be determined using the waveguide pitch (e.g., using the pitch of the waveguide tip) or using the imaging plane. If determining the cantilever's scan range using the pitch of the waveguide tip, then the cantilever's scan range may be based on the pitch between the waveguides and determined from the oscillatory displacement of a center of the cantilever tip. If determining the cantilever's scan range using the imaging plane, then the cantilever's scan range may be based on the pitch between beams projected onto the imaging plane and determined from the amplitude of the Lissajous pattern traced by one of the beams. With these scan patterns, the low repetition rates that are required for large fill factors when scanning with a single beam may be avoided. The fill factors these maximum density multi-waveguide scans can achieve are calculated for different pixel array sizes (see FIGS. 2D and 2E), and find that a multi-waveguide cantilever can achieve densities with >95% fill at rates that are proportional to the number of waveguides added.

In some embodiments, devices (e.g., cantilevers) used in the techniques described herein may include one or more characteristics in common with a previously demonstrated piezoelectrically actuated microcantilever with a broadband silicon nitride waveguide (see M. Saha, A. S. Greenspon, Y. H. Wen, et al. “High-speed off-chip beam steering via photonic integrated waveguides embedded on vertical ski-jump cantilevers,” in Frontiers in Optics+Laser Science 2023 (FiO, LS) paper FTu6E.2.) The device disclosed herein is approximately 70 μm wide and 950 μm long and can emit a beam with a diffraction-limited spot size of about 0.5 μm². The cantilever devices disclosed herein may be fabricated with multiple waveguides spaced apart with a pitch as low as 3 μm, which may allow up to 20 waveguides on a single cantilever. Devices may have x-directional resonant modes at 4.8 kHz and 38 kHz, and y-directional modes at 1.2 kHz, 6.6 kHz, 20 kHz, and 40 kHz. These modes have enough resonant bandwidth to allow us to select from a wide range of drive frequencies in order to produce a target Lissajous pattern with different target lobe numbers, fill factors, and refresh rates for various applications (e.g., image projection, LiDAR scanning, atomic color center excitation, etc.). For instance, for image projection and LiDAR scanning, both large fill factors and high refresh rates are ideal, so adding multiple waveguides to the cantilever allows the cantilever to project high density images with refresh rates in the hundreds of Hz.

For other applications, such as optical initialization and control of arrays of color centers in diamond waveguides, scans that are fast and repeatable over a small area may be desired. In these cases, a multi-waveguide device may be used to project a very small ratio Lissajous pattern that creates an ‘U-shaped’, ‘Oval’, ‘Hourglass’, or ‘M-Shaped’ curve at kHz rates by ‘filling in’ the space between the pitch of the waveguides. In these cases, very little lateral actuation may be required, and the device may project a Lissajous pattern at the spot size of the device. With these patterns (e.g., small ratio Lissajous patterns) and a multi-waveguide cantilever, a beam may be scanned over each of the diamond waveguides on a microchiplet with a diamond waveguide array, which may give access to thousands of color centers with update rates in the kHz or tens of kHz.

FIGS. 3A-3E show various aspects of a microcantilever with separate left and right actuation regions, a quantum microchiplet, and high-rate patterns for addressing waveguides on the quantum microchiplet. In FIG. 3A, a microcantilever with separate left and right actuation regions (e.g., such as cantilever 102 with a first and second piezoelectric layer described in reference to FIG. 1) and 4 embedded waveguides is shown. FIG. 3B shows a photograph of a microcantilever device with 8 embedded waveguides. FIG. 3C shows a frequency response from a single waveguide split actuator device when driving both actuation regions in-phase or out-of-phase. Setting the relative phase allows orthogonal control over the y-directional or x-directional response. FIG. 3D shows an SEM image of a quantum microchiplet with 8 diamond waveguides. The diamond waveguides have a 3 μm pitch and each waveguide contains an array of optically addressable color center emitters. FIG. 3E shows high-rate patterns for addressing waveguides on a quantum microchiplet. Scans can run either parallel to the waveguide array on the quantum microchiplet or perpendicular to the waveguide array on the quantum microchiplet.

### ‘Between the Pitch’ Scanning Via Multi-Waveguide Cantilevers

In some embodiments, a multi-waveguide cantilever may be driven with an AC voltage to cause oscillatory displacement of the multi-waveguide cantilever (e.g., center 206, or 208, of cantilever 202, or 204, of FIG. 2C) in the x-direction and the y-direction that obeys the following x(t) and y(t) equations, if N_{X}≠N_{Y}:

$$x ( t ) = \frac{p - \frac{spotsize}{2}}{2} cos ( 2 π {f}_{X} t + \frac{2 π}{4 ( {N}_{X} - {N}_{Y} )} ) \qquad Equation 5$$

$$y ( t ) = {A}_{Y} cos ( 2 π {f}_{Y} t + \frac{2 π}{4 ( {N}_{X} - {N}_{Y} )} ) \qquad Equation 6$$

If N_{X}=N_{Y}, then the multi-waveguide cantilever may be driven with an AC voltage to cause oscillatory displacement of the multi-waveguide cantilever (e.g., center 206, or 208, of cantilever 202, or 204, of FIG. 2C) in the x-direction and the y-direction that obeys the following x(t) and y(t) equations:

$$x ( t ) = \frac{p - \frac{spotsize}{2}}{2} cos ( 2 π {f}_{X} t + \frac{π}{2} ) \qquad Equation 7$$

$$y ( t ) = {A}_{Y} cos ( 2 π {f}_{Y} t ) \qquad Equation 8$$

Driving a multi-waveguide cantilever via the AC voltage to induce oscillatory displacement that obeys Equations 5-6 (or Equations 7-8) may cause each beam spot from each waveguide of the multi-waveguide cantilever to oscillate within a region bounded by the pitch between each waveguide, such that the oscillations of each beam spot do not overlap with one another. This ‘between the pitch’ scanning may occur because the range of displacement of the multi-waveguide cantilever in the x-direction (e.g., x(t)) is less than or equal to the pitch p between the waveguides of the multi-waveguide cantilever. Conversely, no such limits are imposed on the range of displacement of the multi-waveguide cantilever in the y-direction (e.g., y(t)) for the ‘between the pitch’ scanning. Displacement in the y direction may be arbitrarily large.

### Exemplary ‘Between the Pitch’ Scans

The following serves as simulations of exemplary ‘between the pitch’ scans for a multi-waveguide cantilever with 4 waveguides, such as the multi-waveguide cantilever 202 of FIG. 2C.

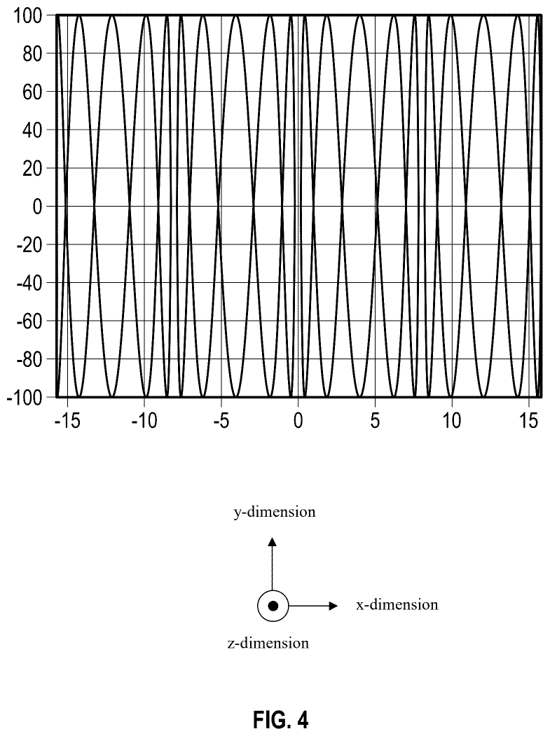

FIG. 4 illustrates a simulated ‘between the pitch’ scan, in which each waveguide of a multi-waveguide cantilever traces a 5:1 (e.g., N_{Y}=5, N_{X}=1) Lissajous pattern. Specifically, the 5:1 Lissajous pattern is simulated with p=8 μm, f_{X}=1000 Hz, f_{y}=5000 Hz, GCD=1000 Hz (e.g., repetition rate of 1000 Hz), A_{Y}=100 μm, and spotsize=1 μm. Such parameters may be inputted into Equations 5 and 6 (or Equations 7 and 8 if N_{Y}=N_{X}). The Equations 5 and 6 (or Equations 7 and 8 if N_{X}=N_{Y}) may be used to predict the oscillatory displacement in the x-direction and the y-direction of the multi-waveguide cantilever as a function of time, thus yielding a simulated ‘between the pitch’ scan.

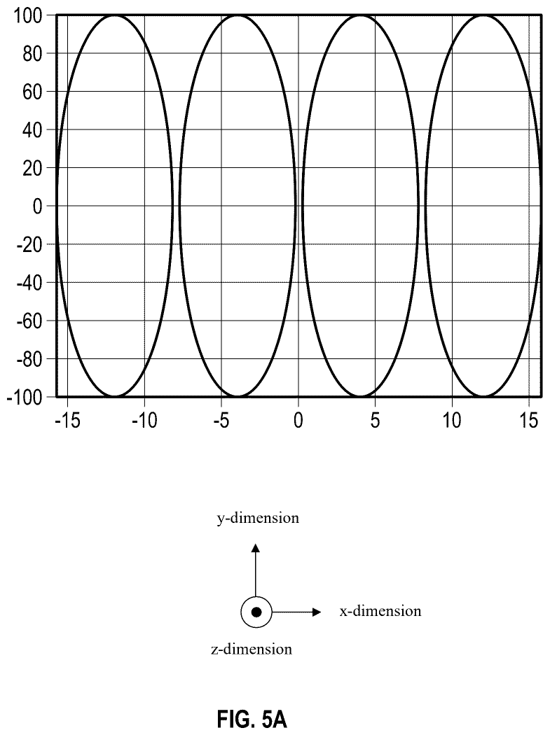

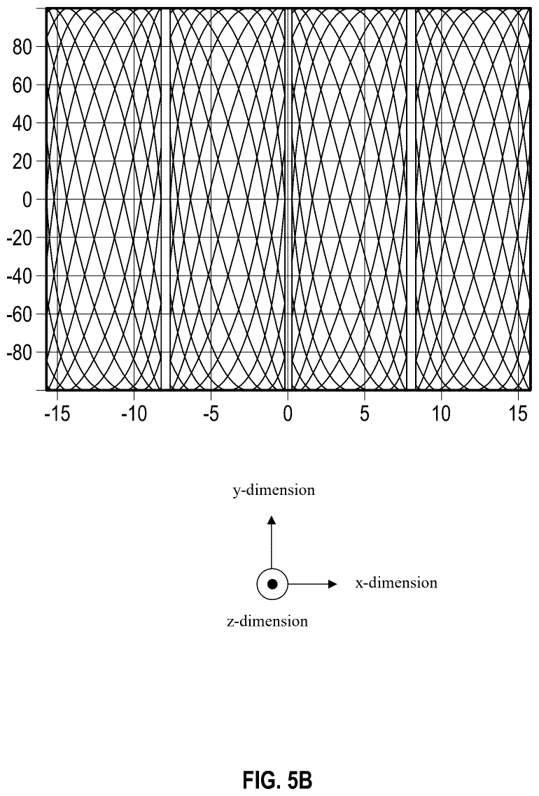

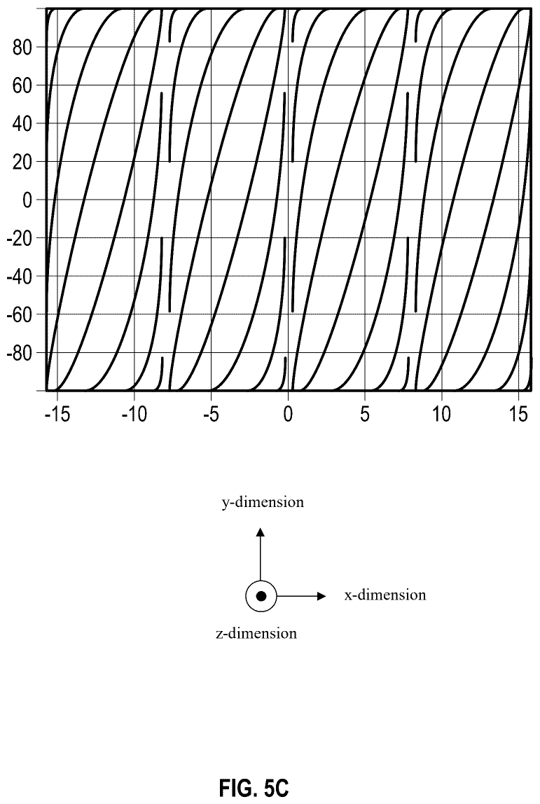

FIG. 5A illustrates a simulated ‘between the pitch’ scan, in which each waveguide of a multi-waveguide cantilever traces a 1:1 (e.g., N_{Y}=1, N_{X}=1) Lissajous pattern. Specifically, the 1:1 Lissajous pattern is simulated with p=8 μm, f_{X}=960 Hz, f_{y}=960 Hz, GCD=960 Hz. (e.g., repetition rate of 960 Hz.). A_{Y}=100 μm, and spotsize=1 μm.

In some embodiments, a frequency difference can be added between f_{X} and f_{Y} (e.g., such that oscillatory displacement of the multi-waveguide cantilever is expressed by Equations 5 and 6 rather than Equations 7 and 8) in order to displace the multi-waveguide cantilever such that the cantilever tip (e.g., thus, waveguide tip) traces a raster-like scan. FIG. 5B illustrates a simulated ‘between the pitch scan,’ in which each waveguide of a multi-waveguide cantilever traces a 9:8 (e.g., N_{Y}=9, N_{X}=8) Lissajous pattern, and the multi-waveguide cantilever is displaced such that each waveguide tip traces the Lissajous pattern as a raster-like scan (e.g., the multi-waveguide cantilever is displaced in accordance with Equations 5 and 6). Specifically, the 9:8 Lissajous pattern is simulated with p=8 μm, f_{X}=960 Hz, f_{y}=1080 Hz, GCD=120 Hz. (e.g., repetition rate of 120 Hz), A_{y}=100 μm, and spotsize=1 μm.

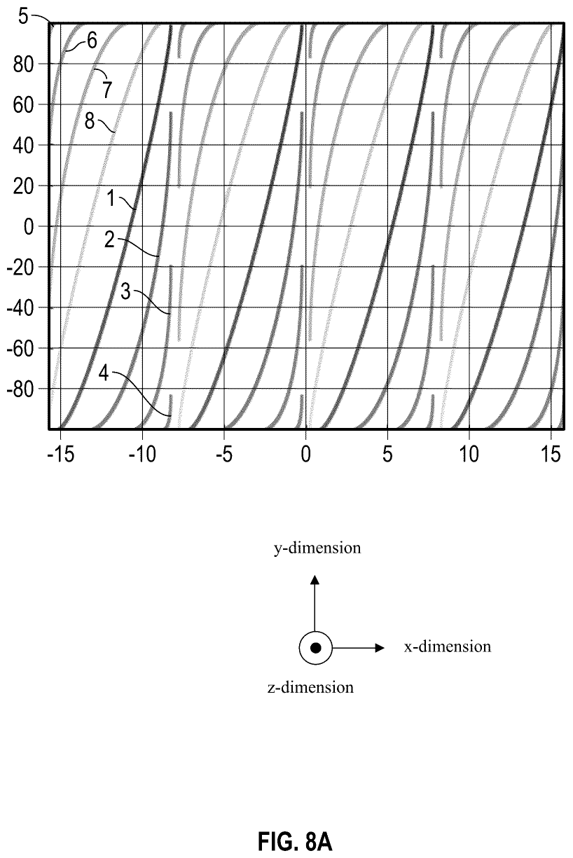

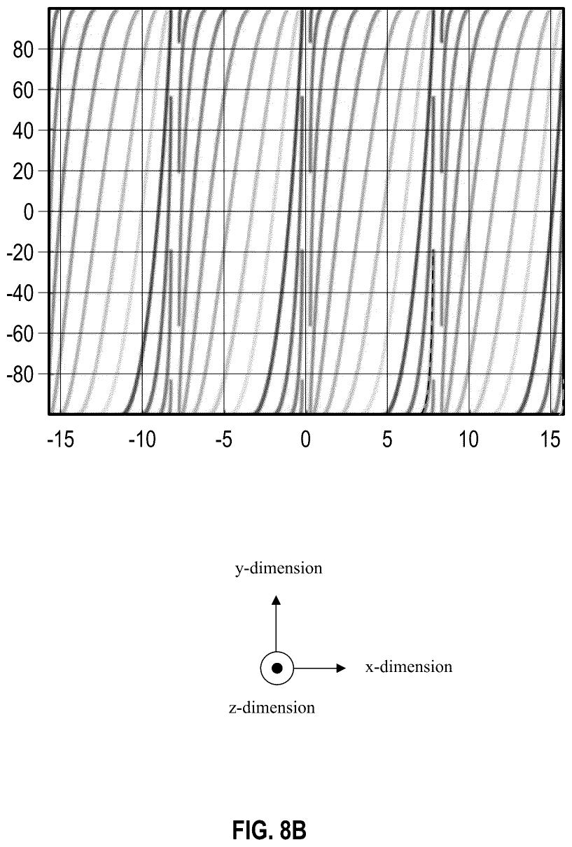

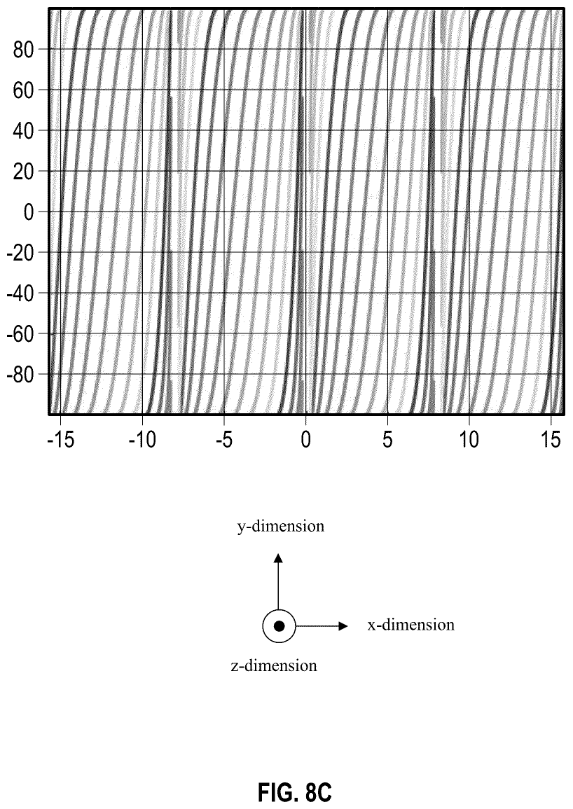

In addition to the frequency difference, in some embodiments, the light coupled into the multi-waveguide cantilever is modulated (e.g., turned on or off) such that the multi-waveguide cantilever projects (e.g., traces) the Lissajous patterns only at certain times during its scanning. In some embodiments, modulation of the light may be used to create dotted patterns and/or dashed lines along the path of the Lissajous pattern traced by the waveguide tip. In some embodiments, the light may be turned on and off such that light is only projected from the tip of the oscillating cantilever (e.g., thus, the tip of each waveguide of the oscillating multi-waveguide cantilever) when the tip is moving in certain directions (and not when the tip is moving in other directions). For instance, the light coupled into each waveguide of the multi-waveguide cantilever may be modulated such that each beam spot from each waveguide of the multi-waveguide cantilever projects the Lissajous pattern only when the multi-waveguide cantilever is moving in a negative y-dimensional direction (e.g., south) and a negative x-dimensional direction (e.g., west). This ‘southwest’ scanning may also yield raster-like scans, in which the multi-waveguide cantilever generates the scanlines of the Lissajous pattern monotonically towards the negative y-dimensional direction and the negative x-dimensional direction (see FIG. 8A). As such, single-directional (e.g., ‘southwest’) scanning of low ratio Lissajous patterns (e.g., low N_{Y}:N_{X} Lissajous patterns) may be easier for users to view as the low ratio single-directional scanning mimics the refresh pattern of a raster scan, which in turn mimics the motional dimming properties of natural light that users' eyes are accustomed to experiencing. The single-directional (e.g., ‘southwest’) scanning may be easier for users to view due to saccadic motions (e.g., quick jerks) of the users' eyes, such that a non-single-directional scan may appear ‘jerky’ or ‘flickery’ to the user. Additionally, the single-directional scanning may make preparing and aligning a cantilever for image projection applications easier as the single-directional scans do not have overlapping scanlines. For instance, non-single-directional scans have overlapping scanlines which appear as bright spots in the imaging plane, and the bright spots can complicate alignment of the projection from the cantilever onto the imaging plane. The light may be modulated (e.g., turned on or off) via a controller, such as controller 122 of FIG. 1.

FIG. 5C illustrates a simulated ‘between the pitch’ and ‘southwest’ scan, in which each waveguide of a multi-waveguide cantilever traces the 9:8 Lissajous pattern of FIG. 5B. Compared to the 9:8 Lissajous pattern of FIG. 5B, the ‘southwest scan of the 9:8 Lissajous includes less scanlines, thus the ‘southwest’ scan of the 9:8 Lissajous pattern may be easier for a user to observe.

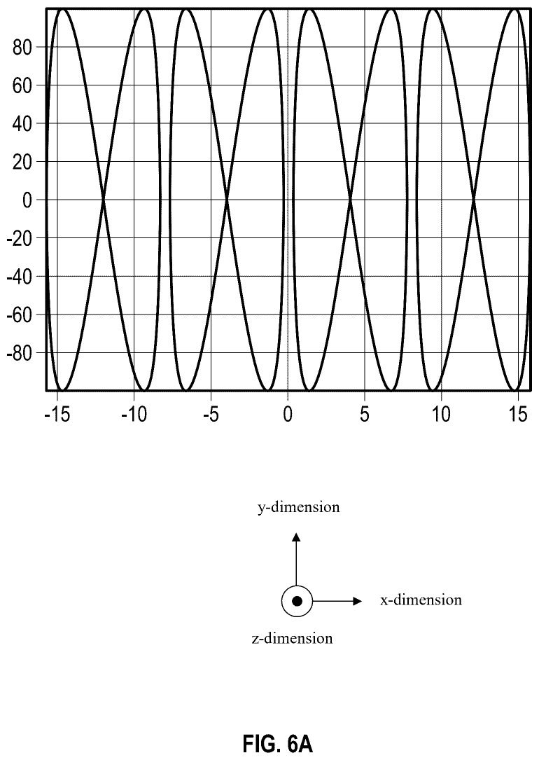

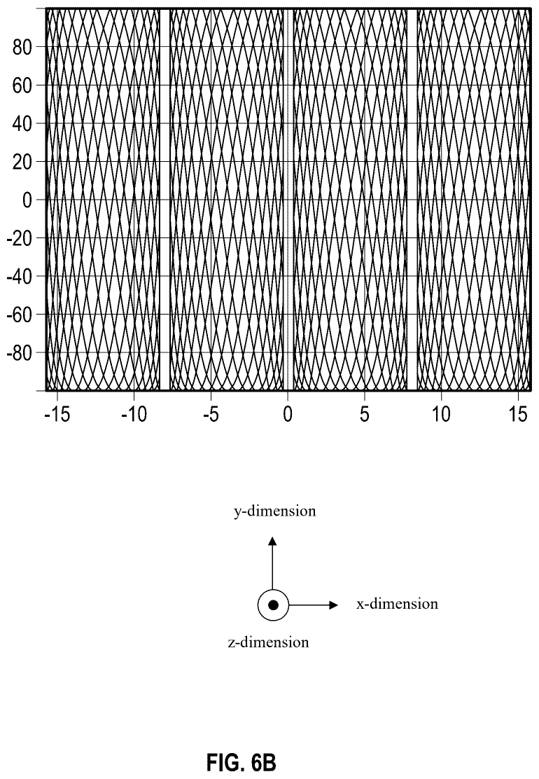

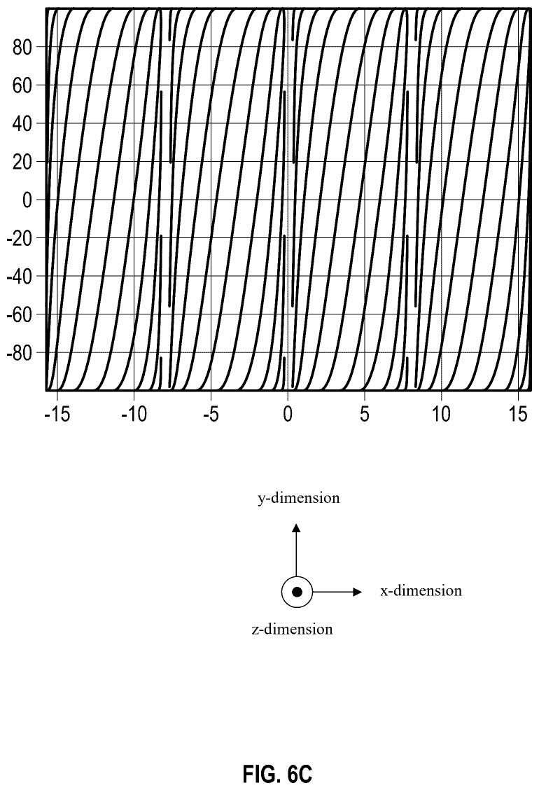

FIG. 6A illustrates a simulated ‘between the pitch’ scan, in which each waveguide of a multi-waveguide cantilever traces a 2:1 (e.g., N_{Y}=2, N_{X}=1) Lissajous pattern. Specifically, the 2:1 Lissajous pattern is simulated with p=8 μm, f_{X}=960 Hz, f_{Y}=1920 Hz, GCD=960 Hz (e.g., repetition rate of 960 Hz), A_{y}=100 μm, and spotsize=1 μm. FIG. 6B illustrates a simulated ‘between the pitch’ scan, in which each waveguide of a multi-waveguide cantilever traces a 17:8 (e.g., N_{Y}=17, N_{X}=8) Lissajous pattern and the multi-waveguide cantilever is displaced with respect to Equations 5 and 6 that causes the each waveguide tip to trace the Lissajous pattern as a raster-like scan. Specifically, the 17:8 Lissajous pattern is simulated with p=8 μm, f_{X}=960 Hz, f_{Y}=2040 Hz, GCD=120 Hz (e.g., repetition rate of 120 Hz), A_{y}=100 μm, and spotsize=1 μm. FIG. 6C illustrates a simulated ‘between the pitch’ and ‘southwest’ scan, in which each waveguide of the multi-waveguide cantilever traces the 17:8 Lissajous pattern of FIG. 6B.

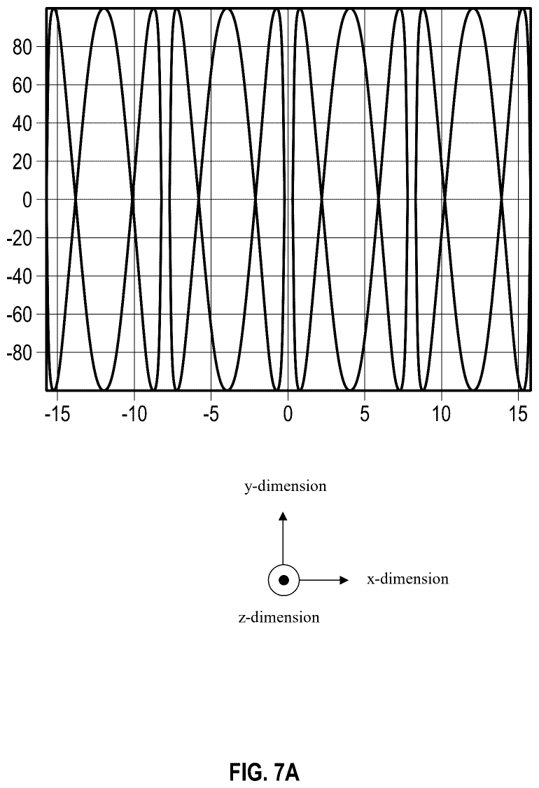

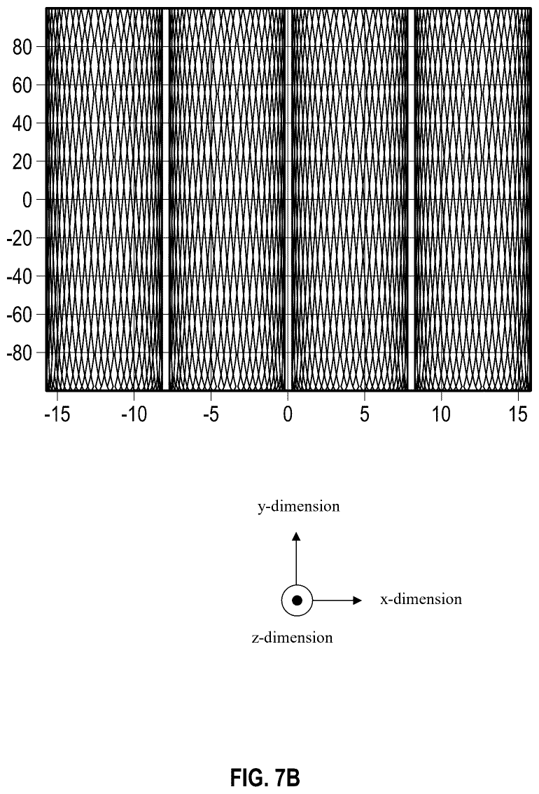

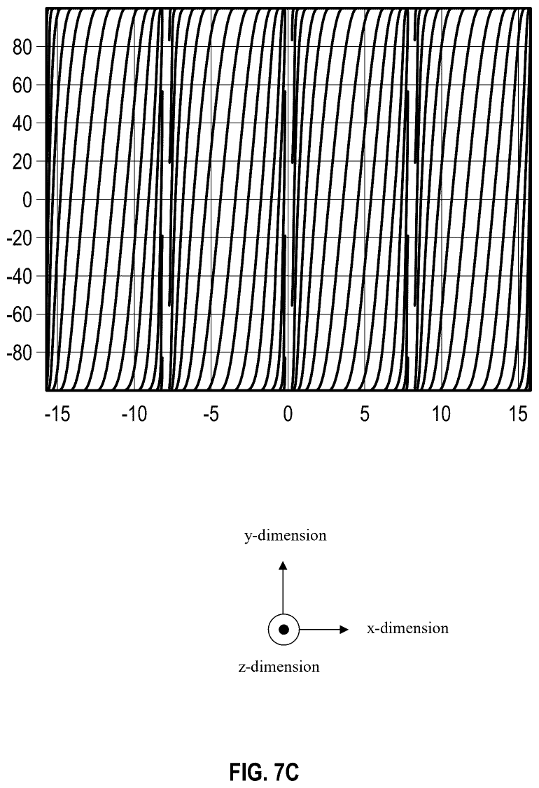

FIG. 7A illustrates a simulated ‘between the pitch’ scan, in which each waveguide of the multi-waveguide cantilever traces a 3:1 (e.g., N_{Y}=3, N_{X}=1) Lissajous pattern. Specifically, the 3:1 Lissajous pattern is simulated with p=8 μm, f_{X}=960 Hz, f_{Y}=2880 Hz, GCD=960 Hz (e.g., repetition rate of 960 Hz), A_{y}=100 μm, and spotsize=1 μm. FIG. 7B illustrates a simulated ‘between the pitch’ scan, in which each waveguide of the multi-waveguide cantilever traces a 25:8 (e.g., N_{Y}=25, N_{X}=8) Lissajous pattern and the multi-waveguide cantilever is displaced with respect to Equations 5 and 6 that causes each waveguide tip to trace the Lissajous pattern as a raster-like scan. Specifically, the 25:8 Lissajous pattern is simulated with p=8 μm, f_{X}=960 Hz, f_{Y}=3000 Hz, GCD=120 Hz (e.g., repetition rate of 120 Hz), A_{y}=100 μm, and spotsize=1 μm. FIG. 7C illustrates a simulated ‘between the pitch’ and ‘southwest’ scan, in which each waveguide of the multi-waveguide cantilever traces the 25:8 Lissajous pattern of FIG. 7B.

FIGS. 8A-8C illustrate simultaneous ‘between the pitch’ and ‘southwest’ scans with various simulated parameters, and with color used to show the temporal order in which lines are traced. FIGS. 8A-8C also illustrate the temporal order in which the scanlines of the ‘southwest’ scans may be traced by the multi-waveguide cantilever. Specifically, for FIGS. 8A-8C, the dark blue scanline is traced first by the multi-waveguide cantilever and the bright yellow scanline is traced last by the multi-waveguide cantilever (see FIG. 8A for numeric labeling of the temporal order). FIG. 8A illustrates a ‘between the pitch’ and ‘southwest’ scan, in which each waveguide of a multi-waveguide cantilever traces a 9:8 (e.g., N_{Y}=9, N_{X}=8) Lissajous pattern with p=8 μm, f_{X}=960 Hz, f_{Y}=1080 Hz, GCD=120 Hz (e.g., repetition rate of 120 Hz), A_{y}=100 μm, and spotsize=1 μm. FIG. 8B illustrates a simulated ‘between the pitch’ and ‘southwest’ scan, in which each waveguide of the multi-waveguide cantilever traces a 9:8 (e.g., N_{Y}=9, N_{X}=8) Lissajous pattern with p=8 μm, f_{X}=960 Hz, f_{Y}=2040 Hz, GCD=120 Hz (e.g., repetition rate of 120 Hz), A_{y}=100 μm, and spotsize=1 μm. FIG. 8C illustrates a simulated ‘between the pitch’ and ‘southwest’ scan, in which each waveguide of a multi-waveguide cantilever traces a 9:8 (e.g., N_{Y}=9, N_{X}=8) Lissajous pattern with p=8 μm, f_{X}=960 Hz, f_{Y}=3000 Hz, GCD=120 Hz (e.g., repetition rate of 120 Hz), A_{y}=100 μm, and spotsize=1 μm.

In some embodiments, the x(t) amplitude term of Equations 5 and 7,

$$\frac{p - \frac{spotsize}{2}}{2} ,$$

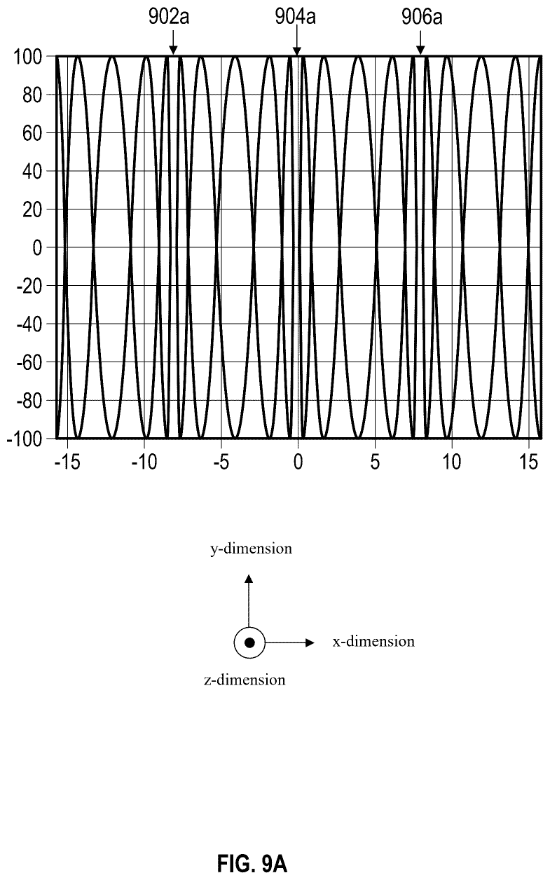

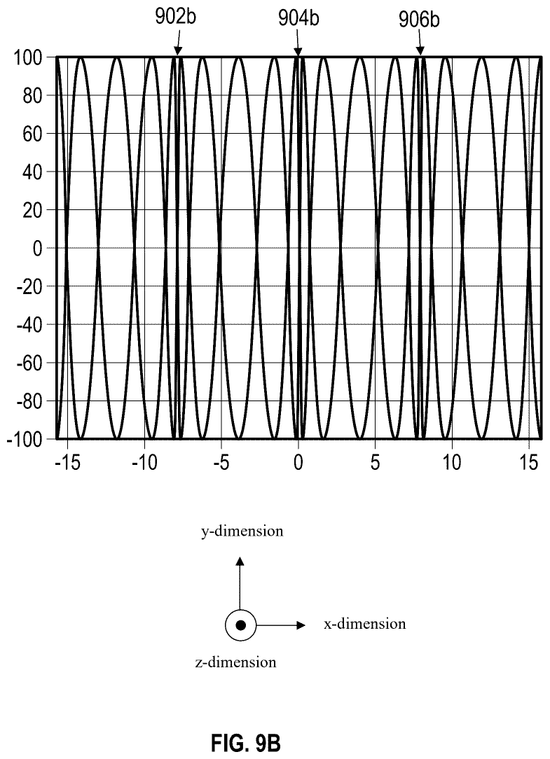

may be adjusted based on the desired Lissajous pattern. For instance, the subtracted term spotsize/2 of the x(t) amplitude may be removed to reduce the spacing (e.g., gap) between the outputs of adjacent waveguides of the multi-waveguide cantilever. FIGS. 9A-9B illustrate that removing the term spotsize/2 from the x(t) amplitude of Equation 5 reduces (and at one point eliminates) the spacing between the outputs of adjacent waveguides. FIG. 9A illustrates a ‘between the pitch’ scan, in which each waveguide of a multi-waveguide cantilever traces a 5:1 (e.g., N_{Y}=5, N_{X}=1) Lissajous pattern across an x-displacement range of

$$\pm \frac{p - \frac{spotsize}{2}}{2}$$

(e.g., the multi-waveguide cantilever is displaced in the x-direction with respect to Equation 5 with the spotsize/2 term). Specifically, the 5:1 Lissajous pattern is simulated with p=8 μm, f_{X}=1000 Hz, f_{Y}=5000 Hz, GCD=1000 Hz (e.g., repetition rate of 1000 Hz), A_{y}=100 μm, and spotsize=1 μm. Labels 902a, 904a, and 906a highlight the spacing between the outputs of adjacent waveguides of the multi-waveguide cantilever. FIG. 9B illustrates a ‘between the pitch’ scan, in which each waveguide of a multi-waveguide cantilever traces a 5:1 Lissajous pattern across an x-displacement range of ±p/2 (e.g., the multi-waveguide cantilever is displaced in the x-direction with respect to Equation 5 without the spotsize/2 term). Labels 902b, 904b, and 906b highlight that removing the spotsize/2 from the x(t) amplitude of Equation 5 reduced the spacing between the outputs of adjacent waveguide of the multi-waveguide cantilever.

### Modulation of Light for More Uniform Raster-Like Scans

In some embodiments, the light coupled into the waveguides of the multi-waveguide cantilever is modulated (e.g., turned on or off) when the range of displacement in the x-direction (e.g., amplitude of x(t) of Equation 5, or Equation 7) is increased to be greater than or equal to the pitch p. Increasing the range of displacement in the x-direction can create Lissajous patterns in which the beam spots from each waveguide of the multi-waveguide cantilever may overlap for certain movements of the multi-waveguide cantilever. For instance, FIGS. 2A(i)-2B(ii) are exemplary Lissajous patterns generated by a multi-waveguide cantilever for which the beam spots from each waveguide of the multi-waveguide cantilever overlapped. As described herein, such Lissajous patterns (e.g., Lissajous patterns in which the beam spots overlap) may be maximally efficient Lissajous patterns as the multi-waveguide cantilever evenly spaces the Lissajous pattern with respect to the waveguide pitch and number of waveguides. Additionally, such Lissajous patterns exhibit minimal ‘bunching’ along the left and right sides of the pattern. However, as described herein, such Lissajous patterns can be visually demanding for a user because of the high density of scanlines. As such, it may be beneficial, for certain applications that benefit from efficient Lissajous patterns with minimal ‘bunching’ that are visually easy to observe, to modulate the light coupled to the multi-waveguide cantilever such that the output of each waveguide (e.g., beam spot) is turned off when the output of each waveguide is outside a predefined zone that is exclusive to said beam. In some embodiments, the light may be modulated via a controller, such as controller 122 of FIG. 1. For instance, the controller may determine the relationship between a desired X-directional displacement (e.g., predefined zone) of each waveguide of the multi-waveguide cantilever and the AC voltage to cause the cantilever to displace each waveguide by said X-directional displacement. Using the relationship between the X-directional displacement and the AC voltage (e.g., as defined in part by a phase offset between the driving signal and the beam tip), the controller may control one or more light sources (e.g., such as lights source 120 of FIG. 1) to not output the light when the multi-waveguide cantilever would be driven with the AC voltage that would displace the multi-waveguide cantilever in an X-direction that exceeds the desired X-directional displacement of each waveguide of the cantilever.

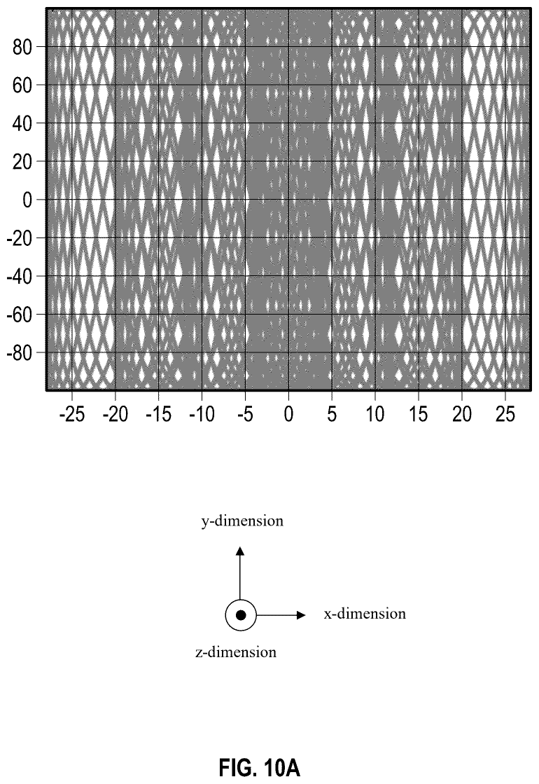

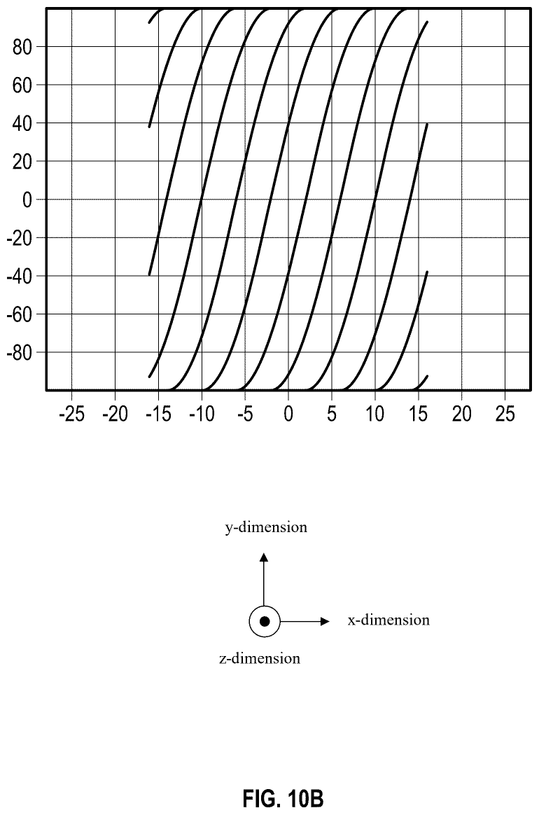

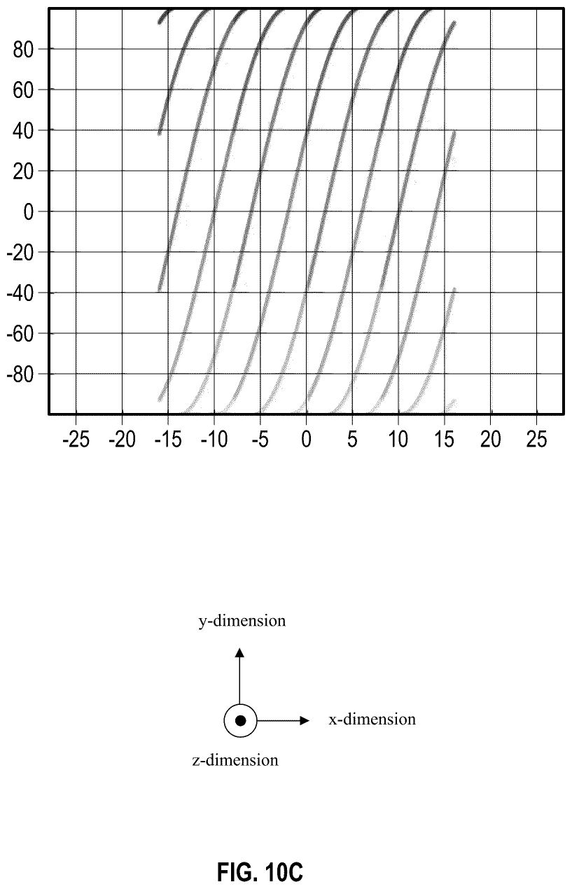

FIG. 10A-10C illustrate aspects of modulating the light coupled to a multi-waveguide cantilever. FIG. 10A illustrates a simulated 9:8 (e.g., N_{Y}=9, N_{X}=8) Lissajous pattern, in which the multi-waveguide cantilever is displaced with respect to Equation 6 and the following equation:

$$x ( t ) = 2 p cos ( 2 π {f}_{X} t + \frac{2 π}{4 ( {N}_{X} - {N}_{Y} )} ) .$$

The 5:1 Lissajous pattern of FIG. 10A is simulated with p=8 μm, f_{X}=960 Hz, f_{Y}=3000 Hz. GCD=120 Hz (e.g., repetition rate of 120 Hz), A_{y}=100 μm, and spotsize=1 μm. FIG. 10A may illustrate a maximally efficient Lissajous pattern with minimal ‘bunching’ along the left and right sides of the Lissajous pattern. FIG. 10B illustrates a simulated ‘southwest’ scan of the 9:8 Lissajous pattern of FIG. 10A, in which the light coupled into the waveguides of the multi-waveguide cantilever is turned off when the x-directional displacement of the cantilever is: |x|>p/2. As such, FIG. 10B illustrates that modulating the light when adjacent waveguide outputs overlap may yield efficient Lissajous pattern with minimal ‘bunching’ that are visually easy to observe due to the low density of scanlines. FIG. 10C illustrates the temporal order in which the multi-waveguide traces the scanlines, where dark blue is traced first and yellow is traced last. Additionally, FIG. 10C demonstrates that modulating the light when adjacent waveguide outputs overlap yields Lissajous patterns that are additionally easy to observe as the beam spots of the multi-waveguide cantilever travel only towards the negative y-direction and the negative x-direction, such as described herein.

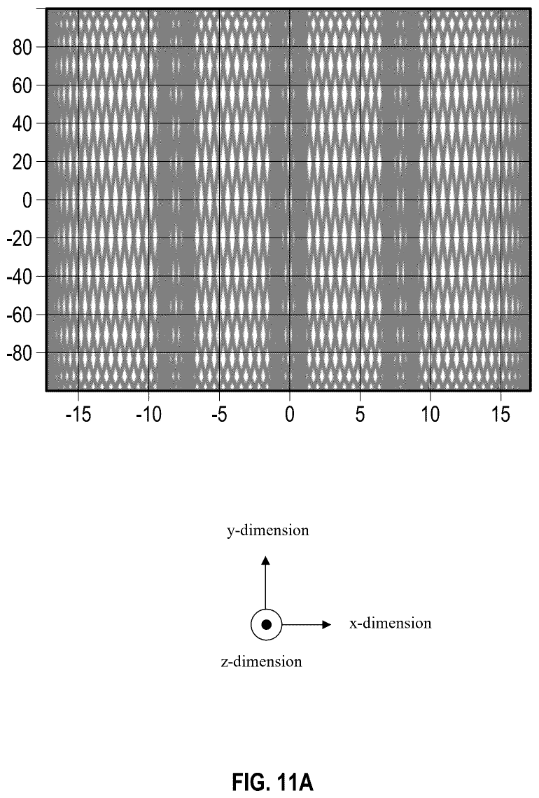

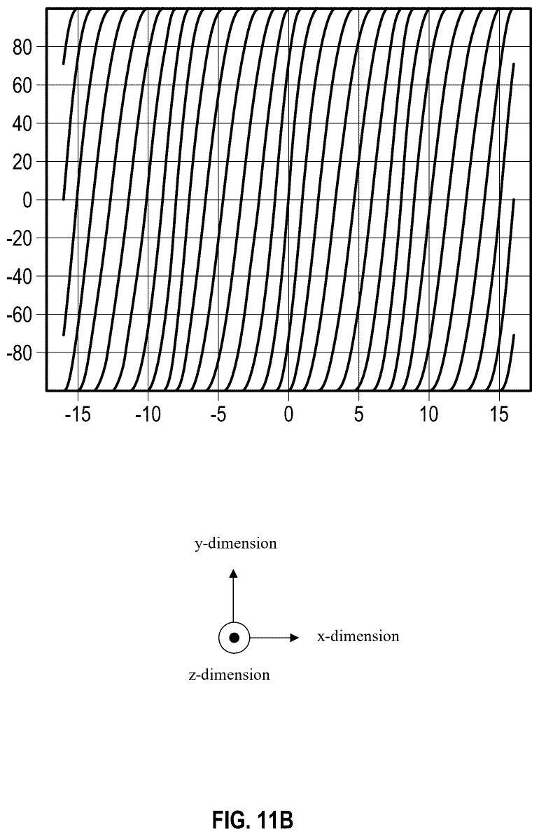

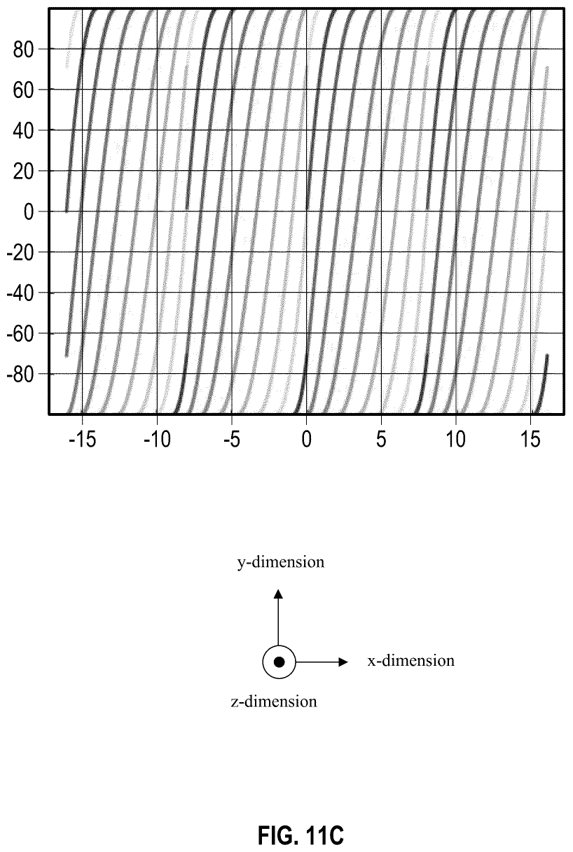

FIG. 11A-11C illustrate aspects of modulating the light coupled to a multi-waveguide cantilever. FIG. 11A illustrates a simulated 9:8 (e.g., N_{Y}=9, N_{X}=8) Lissajous pattern, in which the multi-waveguide cantilever is displaced with respect to Equation 6 and the following equation:

$$x ( t ) = 0.6488 p cos ( 2 π {f}_{X} t + \frac{2 π}{4 ( {N}_{X} - {N}_{Y} )} ) .$$

The 5:1 Lissajous pattern of FIG. 11A is simulated with p=8 μm, f_{X}=960 Hz, f_{Y}=3000 Hz, GCD=120 Hz (e.g., repetition rate of 120 Hz), A_{Y}=100 μm, and spotsize=1 μm. FIG. 11A may illustrate a maximally efficient Lissajous pattern. However, FIG. 11A demonstrates increased ‘bunching’ along the left and right sides of the Lissajous pattern. Displacing the multi-waveguide cantilever with respect to the above equation may yield a Lissajous pattern with additional scanlines, however, the lower range of displacement in the x-direction increases the ‘bunching.’ Displacing the multi-waveguide cantilever with respect to the above equation may be useful for image projection applications as the additional scanlines are associated with more pixels of the image being projected from the multi-waveguide cantilever. It may also be useful for image projection applications as the additional scanlines may be associated with a different frame rate for a given number of pixels. It may also be useful for color center applications as the additional scanlines are associated with more color centers being addressed by the light projected from the multi-waveguide cantilever. The increased ‘bunching’ is observed in the left and right sides of the simulated ‘southwest’ scan of FIG. 11B, which illustrates the 9:8 Lissajous pattern of FIG. 11A. Similarly, to FIG. 10B, the light coupled into the waveguides of the multi-waveguide cantilever is turned off when the x-directional displacement of the cantilever is: [x]>p/2. FIG. 11C illustrates the temporal order in which the multi-waveguide traces the scanlines, where dark blue is traced first and yellow is traced last.

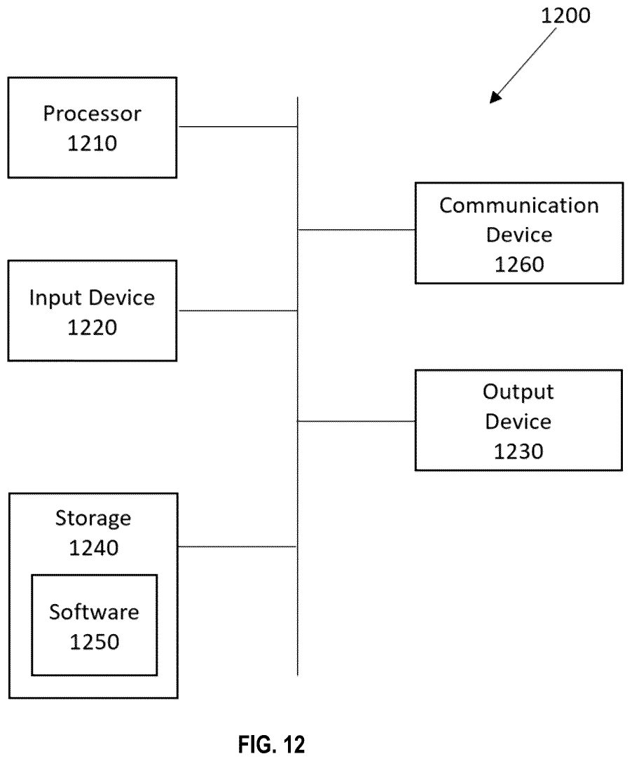

FIG. 12 illustrates an example of a computing system 1200 that may be used for any one of the computing systems and devices described herein, such as for controller of FIG. 1. System 1200 can be a computer connected to a network. System 1200 can be a client computer, a server, a router, a hub, an access point, or any other computing device that can send and/or receive wireless signals or non-wireless signals. As shown in FIG. 12, system 1200 can be any suitable type of microprocessor-based system, such as a personal computer, workstation, server, or handheld computing device (portable electronic device) such as a phone or tablet. The system can include, for example, one or more of a processor 1210, input device 1220, output device 1230, storage 1240, and communication device 1260. Input device 1220 and output device 1230 can generally correspond to those described above and can either be connectable or integrated with the computer.

Input device 1220 can be any suitable device that provides input, such as a touch screen, keyboard or keypad, mouse, gesture recognition component of a virtual/augmented reality system, or voice recognition device. Output device 1230 can be or include any suitable device that provides output, such as a touch screen, haptics device, virtual/augmented reality display, or speaker.

Storage 1240 can be any suitable device that provides storage, such as an electrical, magnetic, or optical memory, including a RAM, cache, hard drive, removable storage disk, or other non-transitory computer-readable medium. Communication device 1260 can include any suitable device capable of transmitting and receiving signals over a network, such as a network interface chip or device. The components of the computer can be connected in any suitable manner, such as via a physical bus or wirelessly.

Software 1250, which can be stored in storage 1240 and executed by processor 1210, can include, for example, the programming that embodies the functionality of the present disclosure (e.g., as embodied in the devices as described above). For example, software 1250 can include one or more programs for modulating the light coupled into the waveguides of the multi-waveguide cantilever.

Software 1250 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1240, that can contain or store programming for use by or in connection with an instruction execution system, apparatus, or device.

Software 1250 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

System 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1200 can implement any operating system suitable for operating on the network. Software 1250 can be written in any suitable programming language, such as C, C++, Java, or Python. In various aspects, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A photonic system comprising:
a cantilever, the cantilever comprising:
a plurality of waveguides spaced from one another in a width of the cantilever to project a plurality of respective beams, the plurality of respective beams spaced with a uniform pitch from one another along a dimension of the width; and
a piezoelectric layer;
one or more voltage sources to apply a voltage across the piezoelectric layer, such that the cantilever deflects along a length of the cantilever when the voltage is applied; and
a controller to drive the voltage to cause a center point of a tip of the cantilever to translate in a two-dimensional Lissajous pattern.

2. The photonic system of claim 1, wherein translating the center point of a tip of the cantilever in the two-dimensional Lissajous pattern causes the beams to form corresponding two-dimensional Lissajous patterns in a target plane.

3. The photonic system of claim 1, comprising memory storing instructions that, when executed by the controller, causes the controller to drive the voltage so as to translate the center point of a tip of the cantilever in the two-dimensional Lissajous pattern as:
$$x ( t ) = p \frac{{N}_{X} {N}_{WG}}{2 \sqrt{2}} cos ( 2 π {f}_{X} t + \frac{2 π}{4 ( {N}_{X} - {N}_{Y} )} )$$
$$and$$
$$y ( t ) = p ( \frac{{N}_{Y} {N}_{WG}}{2 \sqrt{2}} + \frac{{N}_{WG} - 1}{2} ) cos ( 2 π {f}_{X} t + \frac{2 π}{4 ( {N}_{X} - {N}_{Y} )} )$$
wherein:
greatest common divisor (GCD) is equal to repetition rate,
number of waveguides=N_{wg},
the uniform pitch=p,
number of lobes in an x dimension N_{X}=f_{X}/GCD,
number of lobes in a y dimension N_{Y}=f_{Y}/GCD,
total lobe number N=(f_{X}+f_{Y})/GCD,
frequency in the x dimension=f_{X},
frequency in the y dimension=f_{Y},
a direction propagation of light along the waveguides defines a positive z direction of the cantilever, and
the x dimension is the width dimension and is perpendicular to the y dimension, and both the x dimension and y dimension are perpendicular to the z direction and to one another.

4. The photonic system of claim 1, comprising memory storing instructions that, when executed by the controller, causes the controller to drive the voltage so as to translate the center point of a tip of the cantilever in the two-dimensional Lissajous pattern to create U-shaped, oval-shaped, hourglass-shaped, or M-shaped curves at kHz rates.

5. The photonic system of claim 1, comprising a diamond waveguide comprising a plurality of color centers,
wherein driving the voltage to translate the center point of a tip of the cantilever in the two-dimensional scanning pattern causes the beams to scan over one or more of the plurality of color centers.

6. The photonic system of claim 1, comprising:
a first dielectric layer; and
a second dielectric layer overlying the first dielectric layer,
wherein the piezoelectric layer is disposed between the first dielectric layer and the second dielectric layer.

7. The photonic system of claim 1, wherein:
the piezoelectric layer comprises a first piezoelectric portion and a second piezoelectric portion that are spaced apart from one another, and
applying the voltage across the piezoelectric layer comprises applying a first voltage waveform to the first piezoelectric portion and applying a second voltage waveform to the second piezoelectric portion.

8. The photonic system of claim 1, wherein the second dielectric layer comprises a plurality of crossbars oriented at an angle relative to the direction propagation of light along the waveguides in the cantilever to control curvature of the cantilever.

9. The photonic system of claim 1, comprising memory storing instructions that, when executed by the controller, causes the controller to drive the voltage so as to translate the center point of a tip of the cantilever in the two-dimensional Lissajous pattern, wherein maximum displacement in one direction of the tip of the cantilever in an x dimension of the cantilever is less than or equal to half of uniform pitch, wherein:
a direction propagation of light along the waveguides defines a positive z direction of the cantilever, and
the x dimension is the width dimension and is perpendicular to the y dimension, and both the x dimension and a y dimension are perpendicular to the z direction and to one another.

10. The photonic system of claim 9, wherein the center point of the tip of the cantilever is translated in the two-dimensional Lissajous pattern as:
$$x ( t ) = \frac{p - \frac{spotsize}{2}}{2} cos ( 2 π {f}_{X} t + \frac{2 π}{4 ( {N}_{X} - {N}_{Y} )} )$$
$$and$$
$$y ( t ) = {A}_{Y} cos ( 2 π {f}_{Y} t + \frac{2 π}{4 ( {N}_{X} - {N}_{Y} )} )$$
wherein:
the uniform pitch=p,
number of lobes in an x dimension=N_{X},
number of lobes in a y dimension=N_{Y},
frequency in the x dimension=f_{X},
frequency in the x dimension=f_{Y}, and
A_{y} is an arbitrary constant.

11. The photonic system of claim 9, wherein each of the plurality of waveguides is translated in a respective Lissajous pattern within a non-overlapping zone with respect to the other waveguides.

12. The photonic system of claim 9, wherein:
the x-dimension displacement of the cantilever tip is defined by:
$$x ( t ) = {A}_{X} cos ( 2 π {f}_{X} t + {ϕ}_{X} ) ;$$
the voltage causing the x-dimension displacement is defined by:
$${V}_{X} ( t ) = {A}_{V , X} * {A}_{X} * cos ( 2 π {f}_{X} t + {ϕ}_{X} + {θ}_{V , X} ) ;$$
A_{X} is an arbitrary amplitude term for displacement;
A_{V,X} is an arbitrary amplitude term for voltage;
φ_{X} is a phase offset term for the displacement; and
θ_{V,X} is a phase offset term for the voltage.

13. The photonic system of claim 1, comprising memory storing instructions that, when executed by the controller, causes the controller to drive the voltage so as to translate the center point of a tip of the cantilever in the two-dimensional Lissajous pattern, wherein maximum displacement in one direction of the tip of the cantilever the width dimension of the cantilever is greater than or equal to half of uniform pitch, thereby causing overlap between oscillation zones defined by the oscillation of the respective waveguides.

14. The photonic system of claim 13, wherein the instructions cause the controller to activate and deactivate one or more light sources coupled into the plurality of waveguides, wherein the activation and deactivation is timed such that the each of the waveguides projects its respective beam exclusively within a respective oscillation zone associated with the respective waveguide.

15. The photonic system of claim 1, comprising memory storing instructions that, when executed by the controller, causes the controller to activate and deactivate one or more light sources coupled into the plurality of waveguides such that each of the waveguides projects its respective beam exclusively when the cantilever is translating monotonically in one direction in an x dimension of the cantilever and monotonically in one direction in a y dimension of the cantilever, wherein:
a direction propagation of light along the waveguides defines a positive z direction of the cantilever, and
the x dimension is the width dimension and is perpendicular to the y dimension, and both the x dimension and a y dimension are perpendicular to the z direction and to one another.

16. The photonic system of claim 15, wherein activation and deactivation of the one or more light sources causes the projection, by each of the waveguides, of a respective plurality of non-overlapping lines within a respective oscillation zone associated with the respective waveguide.

17. A method,
the method performed at a photonic system comprising:
a cantilever, the cantilever comprising:
a plurality of waveguides spaced from one another in a width of the cantilever to project a plurality of respective beams, the plurality of respective beams spaced with a uniform pitch from one another along a dimension of the width; and
a piezoelectric layer;
one or more voltage sources; and
a controller
the method comprising:
driving, by the controller, a voltage across the piezoelectric layer, such that the cantilever deflects along a length of the cantilever when the voltage is applied, to cause a center point of a tip of the cantilever to translate in a two-dimensional Lissajous pattern.
